(19) United States
(12) Patent Application Publication
(10) Pub. No.: US 2015/0112963 A1
(43) Pub. Date: Apr. 23, 2015

(54) TIME AND LOCATION BASED INFORMATION SEARCH AND DISCOVERY

(71) Applicant: Tilofy, Inc., El Segundo, CA (US)

(72) Inventors: Alireza Mojtahedi, El Segundo, CA (US); Ali Khoshgozaran, El Segundo, CA (US); Amir Raminfar, El Segundo, CA (US)

(21) Appl. No.: 14/522,029

(22) Filed: Oct. 23, 2014

Related U.S. Application Data
(60) Provisional application No. 61/894,691, filed on Oct. 23, 2013.

(51) Int. Cl. G06F 17/30

(52) U.S. Cl. CPC G06F 17/30241; G06F 17/3087
USPC 707/711

(57) ABSTRACT

According to embodiments herein, real-time searching and discovery of topics, stories, events, and incidents may be based on location (a user's current location or a specified location) and time (the current time or a specified time, in the past, present, or future).

### RELATED APPLICATION

This application claims the benefit of U.S. Provisional Application No. 61/894,691, filed on Oct. 23, 2013, by Mojtahedi, et al., the contents of which are hereby incorporated by reference.

### TECHNICAL FIELD

The present disclosure relates generally to online searching and offline information management, and, more particularly, to time and location based searching, discovery, and presentation of information.

### BACKGROUND

Conventionally, search engines focus on indexing data and web pages, and return those that match one or more search terms of a user query. Existing systems, however, are generally ineffective due to how information is disseminated. In particular, the information returned by conventional search engines are often based on a frequency of the search terms within the document or website, or how recent the information (e.g., news) was created, or a number of other websites linking to the results, etc. Often, one of the largest consumer complaints about searching the Internet or World Wide Web (“the Web”) is that there is endless data, but not enough information. For example, users searching for “Boston Marathon” during the tragic bombing of 2013 to determine what was happening amid the chaos might be presented with a history of the Boston Marathon, “Marathon Monday” Boston Red Sox schedules, a story about a runner from Boston who ran in the New York City Marathon years prior, and so on. Conversely, users long after the events of 2013 searching for “Boston Marathon” will receive search results primarily populated with news stories about the bombing of 2013, even if those users are interested in registering for future Boston Marathons, looking for parking information for an up-and-coming Marathon, or writing a report on the woman who allegedly used public transportation in 1980 to win the Boston Marathon's women's category (and later had her title stripped), etc.

### SUMMARY

According to embodiments herein, real-time searching and discovery of topics, stories, events, and incidents may be based on location (a user's current location or a specified location) and time (the current time or a specified time, in the past, present, or future). Other specific embodiments, extensions, or implementation details are also described below.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1-55 illustrate examples of one or more embodiments herein.

### DESCRIPTION OF EXAMPLE EMBODIMENTS

The embodiments herein may generally be performed by a user device (e.g., personal computer, mobile computing device, smartphone, wearable device, etc., as well as communal user devices such as televisions, digital billboards, “smart glass” in buildings, and so on) in conjunction with one or more servers (data processing, databases, indexers, etc.), and various actions described herein may be related specifically to one or both of the user device and/or the servers. In general, the specific type of user device and/or server configuration may be any suitable configuration (e.g., desktop computers, mobile devices, singular servers, server farms, cloud-based computing, etc.), and any reference to particular type of device herein is not meant to limit the scope of the embodiments herein.

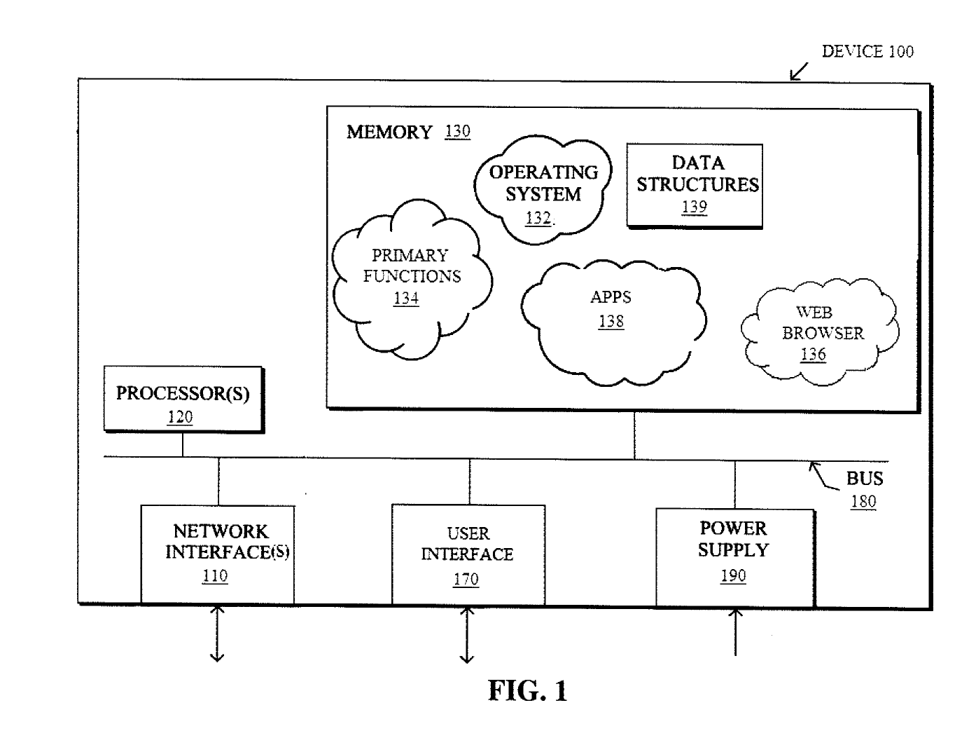

FIG. 1 is a schematic block diagram of an example computing device 100 that may be used with one or more embodiments described herein, e.g., as a user device or a server. The device may comprise at least one network interface 110, at least one processor 120, a memory 130, and user-interface components 170 interconnected by a system bus 180, as well as a power supply 190. Other components may be added to the embodiments herein, and the components listed herein are merely illustrative.

The network interface(s) 110 contain the mechanical, electrical, and signaling circuitry for communicating data over links coupled to a computer network. The memory 130 comprises a plurality of storage locations that are addressable by the processor 120 for storing software programs and data structures associated with the embodiments described herein. The processor 120 may comprise hardware elements or hardware logic adapted to execute the software programs and manipulate the data structures 139. An operating system 132, portions of which are typically resident in memory 130 and executed by the processor, functionally organizes the machine by invoking operations in support of software processes and/or services executing on the machine. These software processes and/or services may (though need not) comprise one or more primary functions 134, a web browser 136, and one or more applications or “apps” 138 (e.g., an option found on many mobile devices). It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Illustratively, certain aspects of the techniques described herein may be performed by hardware, software, and/or firmware, such as in accordance with the various processes and components described herein, which may contain computer executable instructions executed by the processor 120 and/or associated hardware components to perform functions relating to the techniques described herein.

Time and Location Based Information Management

As noted above, search engines conventionally focus on indexing data (e.g., documents, web pages, articles, etc.), and are generally ineffective due to how information is disseminated and used. For example, queries often have a particular location and/or time sensitivity, and current searches are inadequate to relate to such sensitivity (i.e., search engines are conventionally used as tools to find data, not for discovering an unfolding story or happening, and not for something very contextually relevant to them like a local competition that is not indexed by a search engine). For instance, users cannot distinguish two videos belonging to Tahrir Square taken within one year of each other or see everything that happened within two hours during the Boston Marathon bombing. In addition, users cannot currently get real-time updates on what's going on, at anywhere in the world, nor can they generally subscribe to receive real-time alerts about things happening in the future, particularly with regards to specified locations.

The techniques herein provide a manner in which real-time content around a location may be discovered and presented to a user in an intuitive, efficient, and useful way. In particular, the techniques herein intelligently create elements called topics or stories that “did not exist” anywhere on the web (i.e., are created by grouping or clustering results). By helping people find what's happening around them in real-time (what is happening right here, right now), the systems and methods described herein provide a platform for universal discovery of the world's real-time data around any specified location and for any specified period of time.

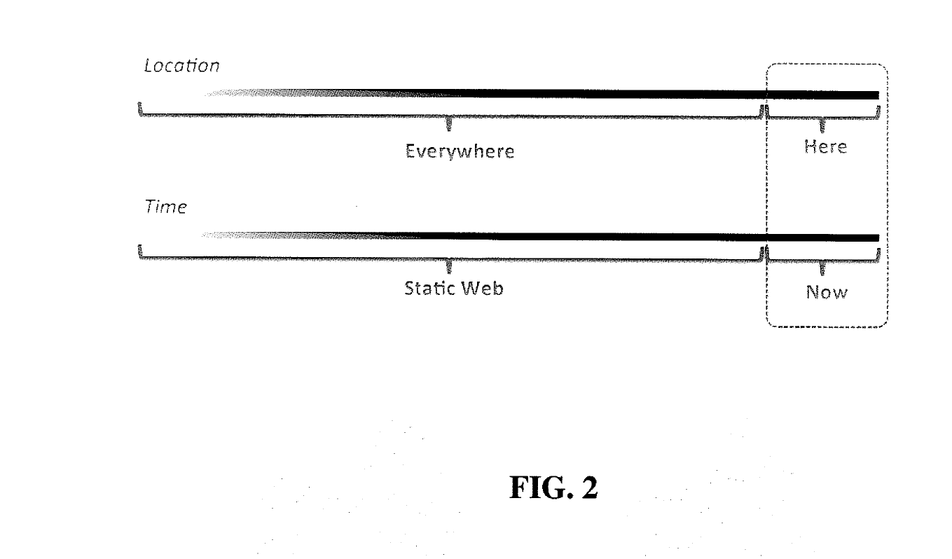

With reference to FIG. 2, conventional searching based on “location” may generally return search results from everywhere in the world, and not a specific location (e.g., “here” or “there”). In addition, conventional searches return hits regardless of their time (a “static web”), and do not relate to specific times (e.g., “now” or “at this specific time”). The techniques herein, however, allow for informative results to be specifically tailored for user-defined criteria, such as “here and now” (or, more generally, “this particular location at this particular time”).

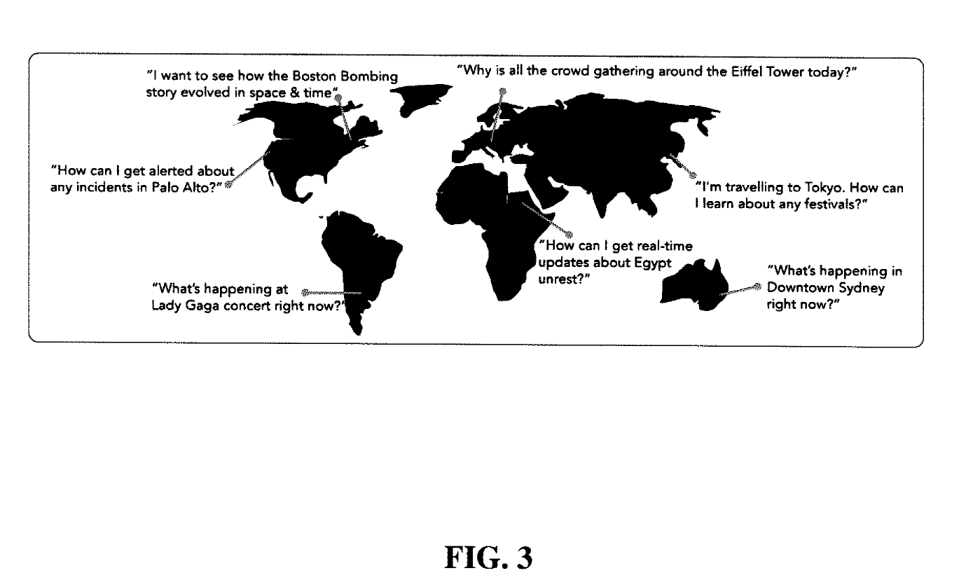

Referring to FIG. 3, for instance, users may independently develop any number of search queries based on one or both of location and time, such as, for example:
“I want to see how the Boston Bombing story evolved in space and time.”
“How can I get alerted about any incidents in Palo Alto?”
“What's happening at Lady Gaga's concert right now?”
“Why is all the crowd gathering around the Eiffel Tower today?”
“I'm travelling to Tokyo. How can I learn about any festivals?”
“How can I monitor my child's school and follow happenings such as emergencies, events, etc. in real-time?”
“How can I get real-time updates about Egypt's unrest?”
“What's happening in Downtown Sydney right now?”
And so on.

The techniques described herein (and detailed below) add to tag-based and keyword search and discovery by allowing for results that focus on specific times and specific locations, such as real-time nearby data (e.g., “why is a crowd gathering near me right now?”) for serendipitous discovery, where the information is organized in a functional and custom-tailored manner. In addition, as described below, certain embodiments herein also allow for time and location-based subscriptions (e.g., alert settings), to be kept abreast of developing stories, news, and events, anywhere in the world.

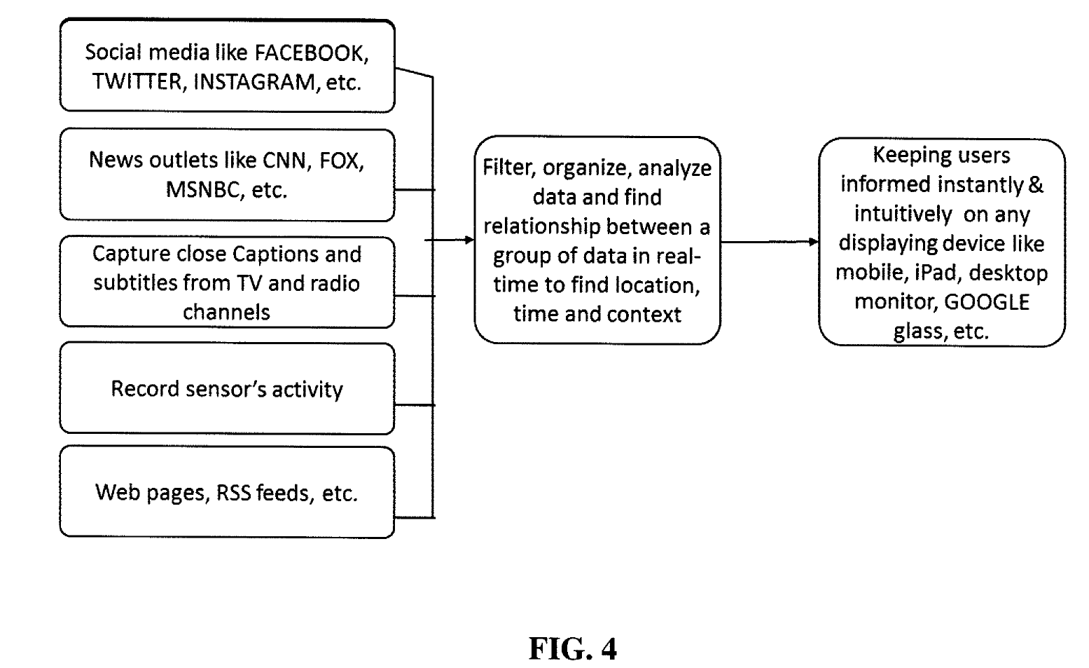

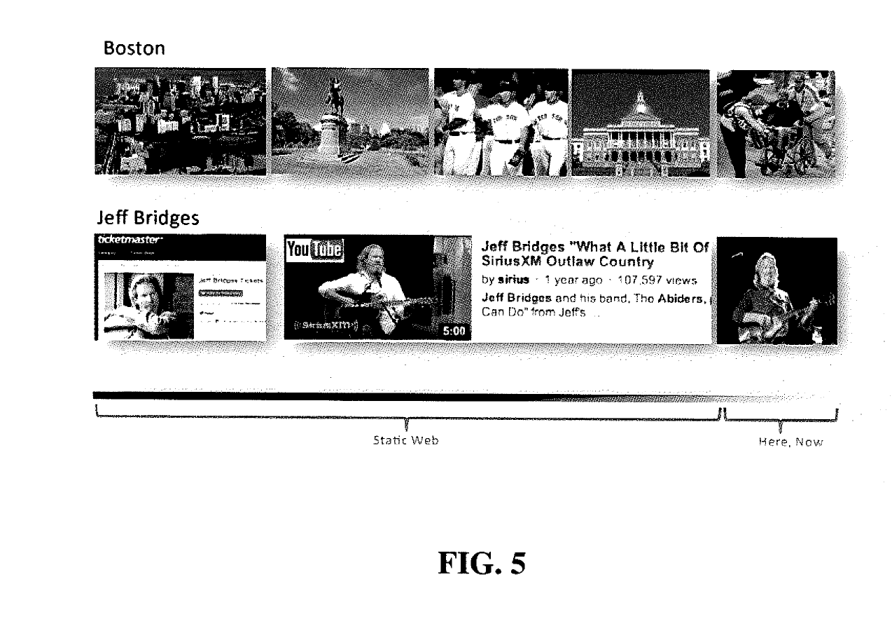

As illustrated in FIG. 4, by taking disparate real time data sources, such as social media activity (FACEBOOK, TWITTER, INSTAGRAM, etc.), news outlets (e.g., CNN, FOX, MSNBC, etc.), exclusive data, rich site summary (RSS, also referenced as “really simple syndication”), closed captions and subtitles from TV and radio channels, sensors, web pages, and any other source of related content/data (online, offline, sensor/hardware-based, etc.), and then organizing this data into “topics” (described below) based on time and location (e.g., “SFO plane crash”), users can be kept informed of such topics in an intuitive (and instantaneous), manner. For instance, with reference to FIG. 5, searching for “Boston” without any other indicators (“static Web”) may result in information about the city, landmarks, sports schedules, legislation, etc. However, searching for “Boston” within the context of “here and now” (e.g., in April of 2013), would have resulted more specifically in the events and social postings surrounding the Boston Marathon bombings. Similarly, generically searching for a favorite artist, such as Jeff Bridges, in the static Web may result in certain movies, songs, YOUTUBE videos, and so on. However, within the context of searching by location and time, a user may more specifically pinpoint a Jeff Bridges concert happening that day in their town.

As described herein, the techniques take data that is generally fragmented and disorganized, and presents this data in a format based on time and location that is more in-tune with the user's query. (Notably, relevance to a user's query may be “fuzzy”, such as where a user's search term is “emergency”, but when a “fire” or “robbery” happens, this would still match the search.) In other words, the techniques herein reduce the “noise” associated with online searching, to focus the results into organized topics.

Discovery

A first aspect of the inventive techniques herein is to locate and/or index “everything”, such as data, articles, pictures, videos, posts, comments, maps, traffic reports, police reports, etc., that can be located, whether online or offline, such as through exclusive sources, sensors, etc. Various techniques may be used for real-time data ingestion and indexing, such as “bots”, “crawlers”, etc., into any available source, such as any online source on the Internet, or from specific limited online sources (e.g., TWITTER, INSTAGRAM, FACEBOOK, CNN, etc.), as well as closed captions and subtitles, sensor data, etc. The intake of data during the discovery phase need not be related to a specific search, nor related to a specific time, and may be performed on data made available in the past (e.g., established web pages, archived news articles) as well as responsive to new information, such as new RSS feeds, recent posts/uploads, etc. (Notably, the elements may also be normalized and “cleaned” for indexing, such as removing ads, removing low-quality documents by checking source, URL, HTML content, images, etc., identifying document title, subject, main paragraph, header, footer etc., removing spam URLs, removing duplicates, comparing white space ratio to character ratio, removing extra parameters from URL, cleaning photos and finding best photo that represents article, finding all entities and city names in the content of the body, and so on.)

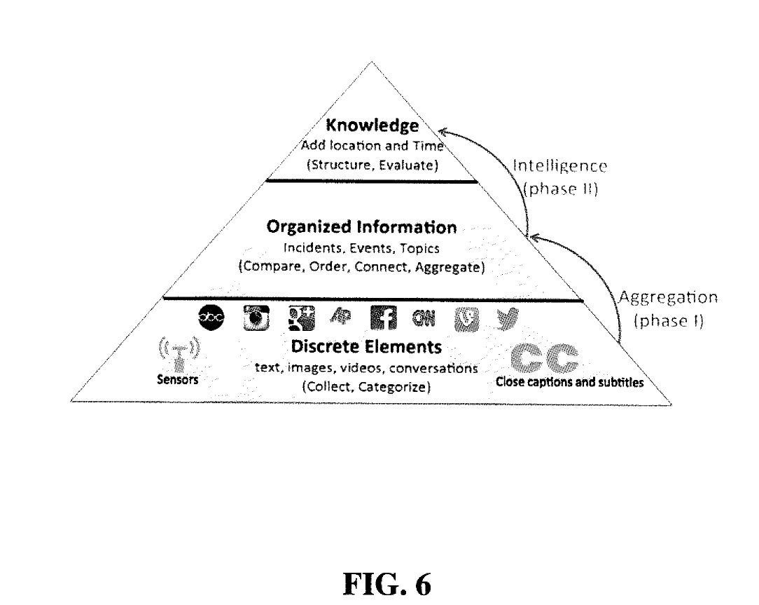

For example, according to the techniques herein, and with reference to FIG. 6, the vast expanse of discrete discoverable elements (e.g., text, images, videos, conversations, etc.) are collected and categorized, and then may be aggregated into collections of organized information. For instance, the elements (e.g., conversations, documents, etc.) may be clustered into incidents, events, topics, stories, etc., for easy user consumption. Note that as defined herein, a “topic” is a data descriptor that may be assigned a title and region/location, as well as other attributes, such as a measure of importance, one or more media representations (e.g., a picture, video, etc.), and other attributes that may be used to decide which topics may be relevant to each search/discovery, as described below.

Also, the techniques herein may apply an “auto-tagging” technique to elements to create better quality data. For example, when the system identifies references of a location/place in an article (e.g., Wynn hotel), the system may “auto tag” the article with Las Vegas, Hotel, Travel, etc. Also, when the system identifies the time the article was written (e.g., last Tuesday), the system may “auto tag” the article with “this week”, “this month”, “this year”, etc. As a further example, when the article mentions a place/landmark, the system can “auto tag” it with the city, state, country (etc.) to which the article relates. In computer science this may be referred to as “hypernyms.” For instance, an orange is a fruit, so the system could tag any article about oranges with “fruit” also.

According to one or more embodiments herein, a machine algorithm may analyze and compare the data to apply an intelligent clustering algorithm based on location and time to cluster elements/documents. The new cluster of documents can be location and time topics that are presented to users. In other words, the machine algorithm may compare, order, connect, and aggregate the information, and applies intelligence through structure and evaluation to add the notion of location and time to the events and topics to create a knowledge base not before available through searching. The illustrative machine algorithm may dynamically determine (discover, label, etc.) topics for each region and time through a variety of techniques, such as spatial document clustering (documents created in/near the same location), temporal document clustering (documents created in/near the same time), textual document clustering (documents created with the same/similar terms), social/embedding rank linkage (documents that are related through cross-reference, cross-linking, similar linking, “information velocity” (defined below), etc.), and so on, as well as any combination of the above. The system in certain embodiments herein may then correlate the documents (images, text, video titles, etc.), and may dynamically determine a topic title, such as “Boston Marathon Bombing” or “SFO Plane Crash”. Also, based on the space, time, and topics, suggested tags may be generated, such as “Boston”, “marathon”, “bombing”, “manhunt”, “April 2013”, “Boylston Street”, etc.

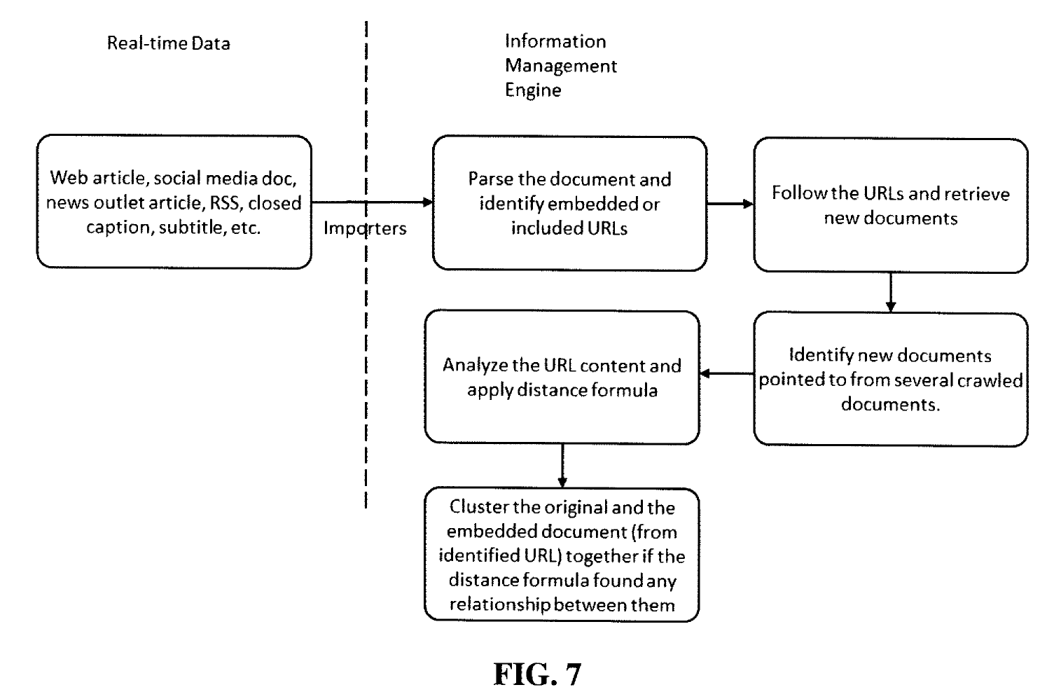

Note that other criteria may be used for clustering, such as authors, city names, or anything relating a set of elements/documents to the same topic. For example, with reference to FIG. 7, one way information can be clustered according to the techniques herein is to take several seemingly unrelated documents (e.g., TWEETS) each with an embedded URL, where by following those URLs, the platform herein can understand that two documents are actually covering the same entity (name, city, event, etc.), allowing the platform to cluster them together.

In general, the techniques herein for tagging and titling may follow one or more algorithms based on the “who”, “what”, “when”, “where”, “why” (and “how”), of each data element discovered during the data ingestion, as well as user consumption of the data (e.g., users' usage patterns). Also, for defining specific locations (e.g., “here” or “at this specific place”) may be based on clustered location points (e.g., SFO airport, Boston, Egypt, northern Africa, etc.), while defining specific times (e.g., “now” or “at this specific time”) may be based on clustered (e.g., bell curves) points in time (e.g., April, Summer, 2013, today, etc.). Notably, the time of a specific incident may be based on when the element was created (e.g., news stories, posted comments, shared TWITTER feeds, etc.), as well as a particular date referenced within the element (e.g., documentaries about World War II in the early 1940's, a book about the Ming Dynasty from the 14th to 17th Centuries, etc.).

Said differently, the techniques herein provide density based time clustering and density based location clustering, as described in greater detail below. For instance, for time clustering, the techniques herein plot all data points along with the one-dimensional time axis. The techniques then use the distribution of the data to identify clusters. These clusters might be used to group data and present them to users or might be used to dynamically and intelligently define “now”. For instance, for very high density data along time dimension, because of data distribution, the system might decide that “NOW”=the past five minutes. But for another example, a different data distribution in time might result in NOW=the past 72 hours. Regarding density based location clustering, the techniques herein plot all data points, use the topology and the proximity to identify clusters of data to show to users or to use to intelligently define “HERE” or “NEARBY”. This is similar to time but in two dimensions. So again, for one topic, if two datapoints are 100 meters away from each other, they might be clustered together or might be tagged “NEARBY”. But for another spatial distribution, five documents being located in a five mile radius might be considered “HERE” or “NEARBY. Alternatively or in addition, “spatial clustering” may take all points in a two-dimensional space, which may be geolocated to a business entity, a venue, a parcel data (critical parcel and building information for commercial and residential real estate). The system herein may then group all points that get mapped to the same entity/parcel/building/venue.

Accordingly, the techniques herein allow for readily searching information based on location and time, whether current events or events in the past. Also, by establishing a real-time index of information, that is, a collection of articles, posts, comments, etc., that is updated in real-time, the techniques herein also connect people to the world's real-time local knowledge (“what's happening here and now”). Notably, as described below, certain embodiments herein also provide for searching information based on events in the future (e.g., subscription based searching).

In addition, there are several times that no meaningful topic can be created/inferred from a numerous set of conversations within a time/location. For those cases there are several innovative ways to present something meaningful to the user:
a) Increase (linearly, sub-linearly, exponentially, etc.) the time, the location, or both dimensions until a sufficient amount of “good” topics are identified. The increase can also vary from user to user depending on past user interest, such as the difference between being “further” in location but “closer” in time versus being “closer” in location but “further” in time. For instance, some users might like things that are up to a week past but are very near them as opposed to some other users who might enjoy things even five miles away as long as they happened within the past hour.
b) Use historical data to “predict” what is likely to happen within a certain time/location interval close to user's existing time and location.
c) Organize/filter documents based on data source (TWITTER, FACEBOOK, etc.), data type (images, video, etc.), popularity (what documents other users have found “interesting” on the platform herein, or what documents are “popular” outside of the platform), based on user's past behavior (user has shown interest in entertaining elements in the platform), generic categories (fun, emergency, etc.), users' explicit interest (e.g., presenting a set of generic or dynamic categories such as politics, celebrities, emergency, finance, tech, etc. to users on initial execution of the associated app to capture users' interest and apply these interests in this particular situation).

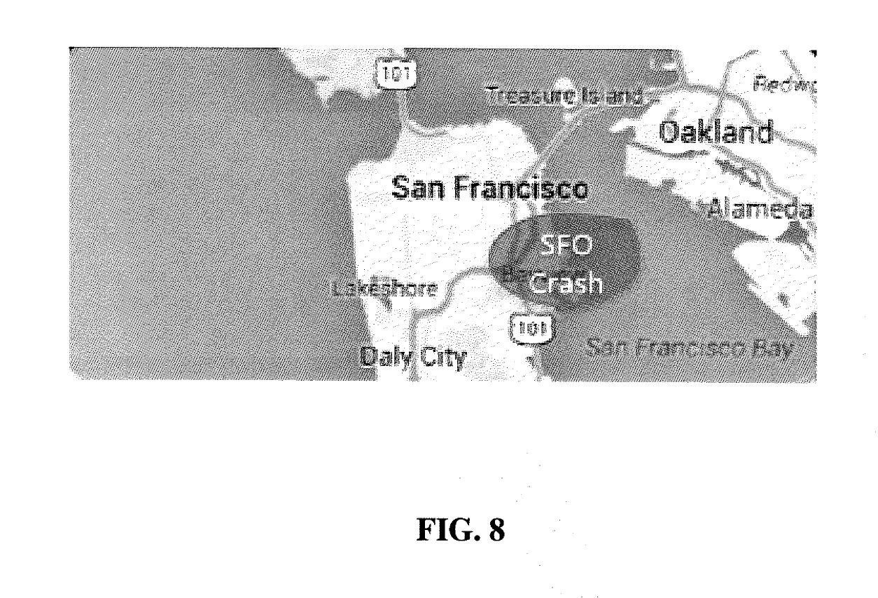

Note that the techniques herein may also create a “heat-map” of events, in both real-time and based on selected time periods, which may be shown in real-time, based on specific search terms or topics (or just general activity in the area), or even as an animated graphic showing major events through time and location. For instance, with reference to FIG. 8, imagine that during the SFO plane crash of 2013, a large number of newly generated online elements (TWEETS, FACEBOOK posts, etc.) appeared at the same time relating to the crash. The referenced location and/or the location of the sources of the information may be mapped to a specific region around the SFO airport, resulting in a displayable graphic relating to the incident. Conversely, imagine a similar heat-map for the Boston Marathon bombing of 2013, where first the “heat” of topics and conversations is centralized over downtown Boston on Monday afternoon, particularly near the marathon's finish line on Boylston Street. On Friday of that week, a new heat-cell would appear over Watertown, Mass., as the bombing suspects fled Boston into the surrounding area. (One could imagine also that the general fact that there was a Marathon in Boston would result in a degree of “heat” being generated in terms of runners, spectators, well-wishers, etc., posting about the actual Marathon, and then a heat-spike would occur once the bombings took place.) The techniques herein may thus show the various levels of “heat”, as a singular graphic, animation over time, etc. More specifically, two generic factors can affect the “heat” measure: 1) Number of documents created or processed in unit of time and/or unit of location; and 2) Amount of user activity around those generated documents in unit of time and/or unit of location. Note that this is a generalization of information velocity which only tracks information spread across a social network (social network, subtitles or closed captions on TV or radio, web pages, etc.) within a unit of time. Note that heat-map animation may be shown over time, either forward or in reverse, showing how data was collected over a specific time range (e.g., recording and replaying the data and showing its distributive velocity/activity over a given region through time).

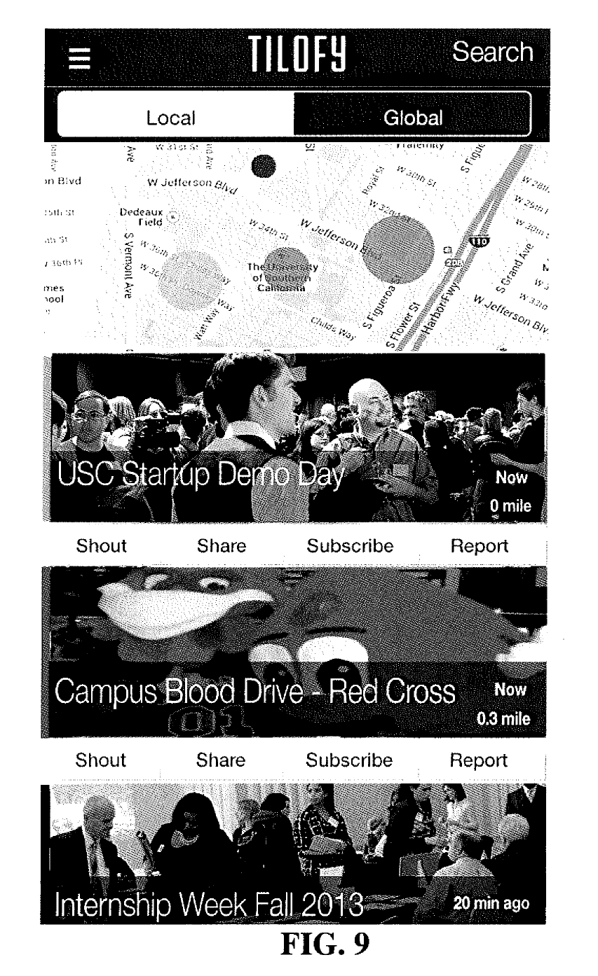

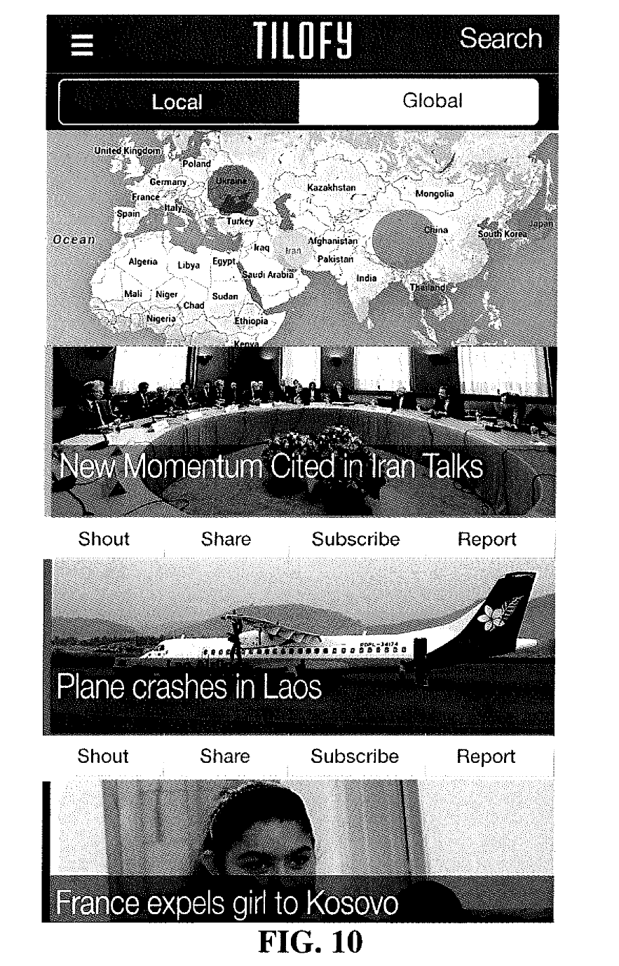

Heat-maps may also be generally created per topic, e.g., locally and/or globally, specifically searching for those particular topics, such as illustrated in FIG. 9 (local) and FIG. 10 (global).

Search

According to one or more embodiments of the present invention, users (or autonomous software programs) may search the discovered and categorized topics based on one or both of time and location, as well as tags, topics, keywords, categories, etc., and combinations thereof. In general, the search algorithms may be similar to conventional searching, except now additional fields (e.g., terms within a search string or specific entries) may be related specifically to time and location. Alternatively, time and/or location may be implicit search parameters, such as where none are provided. Moreover, instead of search keywords, things such as “happening now”, “spreading fast”, “near me”, etc., can replace basic keyword searches.

Time, for instance, may be one or more specific times (past, present, future), a range of times, a periodic time (e.g., seasons), the current time (a time at which a search is performed), and so on. The time search itself may be a text string, any defined interval of time, a “slider” to independently indicate each of a start and stop date, a slider that represents a length of time (e.g., a day, week, month, year) that can be moved into the past to see a history of results during that time, etc. Note that a slider may be non-linear and have a different “level of detail” based on the density of data along the time dimension. Further, alternatively or in addition, things like “happening now”, “just happened”, “rising stories”, etc. can replace conventional time or time interval input parameters.

Location, on the other hand, may be a specific user-defined location (e.g., a current location, a desired location), a specific or general location associated with the user's device (e.g., GPS-based, network-based, settings-based, etc.), and so on. For instance, any definable region may be specified, ranging from pinpoint locations (e.g., addresses, coordinates, etc.) to neighborhoods, cities, states, countries, and even celestial locations (e.g., searching for articles and events on Mars). Entering a particular location may be based on language string searches, drop-down menus, map-based selection (pre-defined regions, free-drawn regions, etc.), and others. Also, as noted above, things like “happening near regions/spaces I care”, “happening in my neighborhood”, “happening at a state level”, “near where my kid goes to school”, “anywhere I have a friend”, “my commute path”, “my favorite locations”, etc. can replace a conventional location parameter. Notably, the techniques herein allows viewing the whole world to see what is going on, or viewing a much smaller localized portion of the overall data. For instance, location can be with a 10,000-mile radius which could mean the planet, or just five miles.

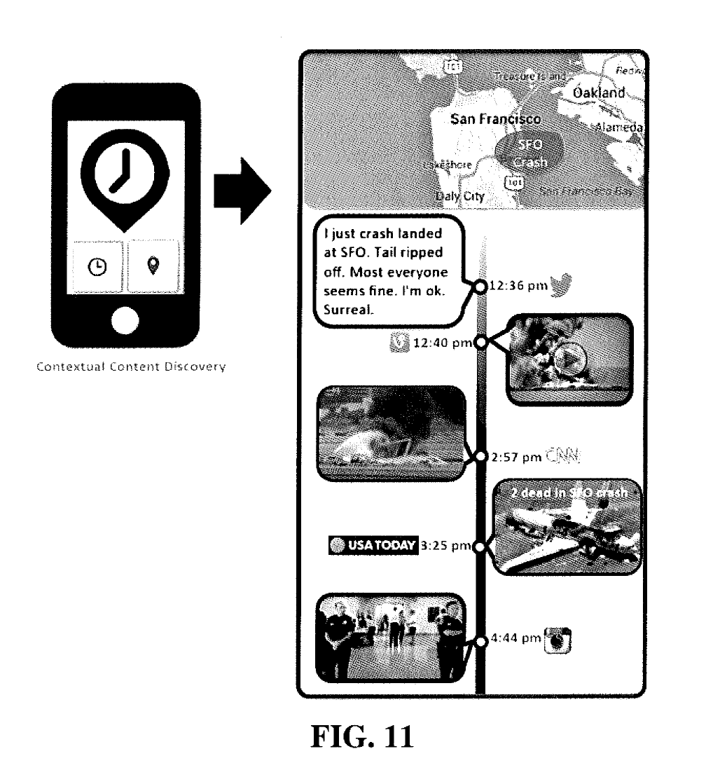

By combining the time and location, a myriad of possibilities are presented to the user (or software-based search engine), such as searching for all events “near me, now”, or all events “in the summer of 1969 in San Francisco”. For example, with reference to FIG. 11, the contextual content discovery of events based on time and location can result in a time-line feed of events surrounding a particular event in a particular location, such as the SFO plane crash of 2013. As can be seen, the general location may be shown, as well as a history of relevant online elements, such as the initial TWEET by the captain of the airplane, followed by selected pictures taken after the crash, available from various media outlets, and illustratively organized intelligently into a topic as created by the platform described herein. While in one example the location may have been entered by a user, in other example embodiments the techniques herein allow for a “zero-click” information discovery, where a user may merely start the associated search application, and by dynamically determining a user's current physical location (e.g., near San Francisco), current events/topics may be displayed to the user. This is particularly useful, for example, when discovering a crowd of people, a power outage, traffic, smoke, etc. Note that the data elements (e.g., events, conversations, etc.) around a particular topic may be presented to the user in a chronological, proximity-based, or any other relevance ranking. Note that data may also be presented in relevance order, i.e., which is most relevant to the user. For example, if the user searches for “orange balls” near 90210 then the system may opt to show all documents that have both “orange” and “ball” in them. Next, the system may show further documents in distance that have “orange” and “ball” or closer documents that just have the word “ball”, etc.

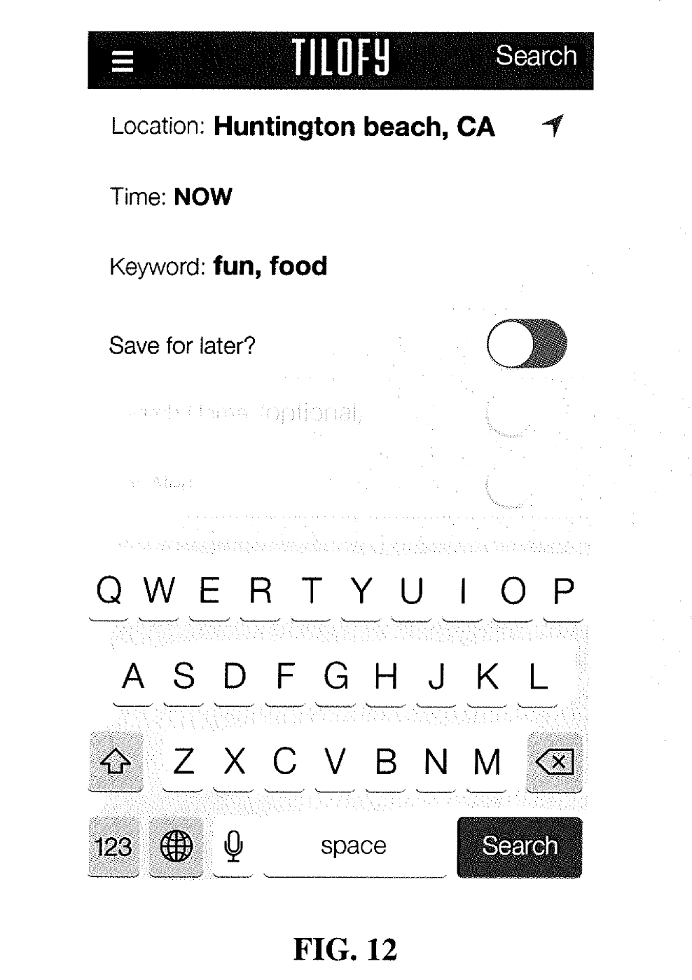

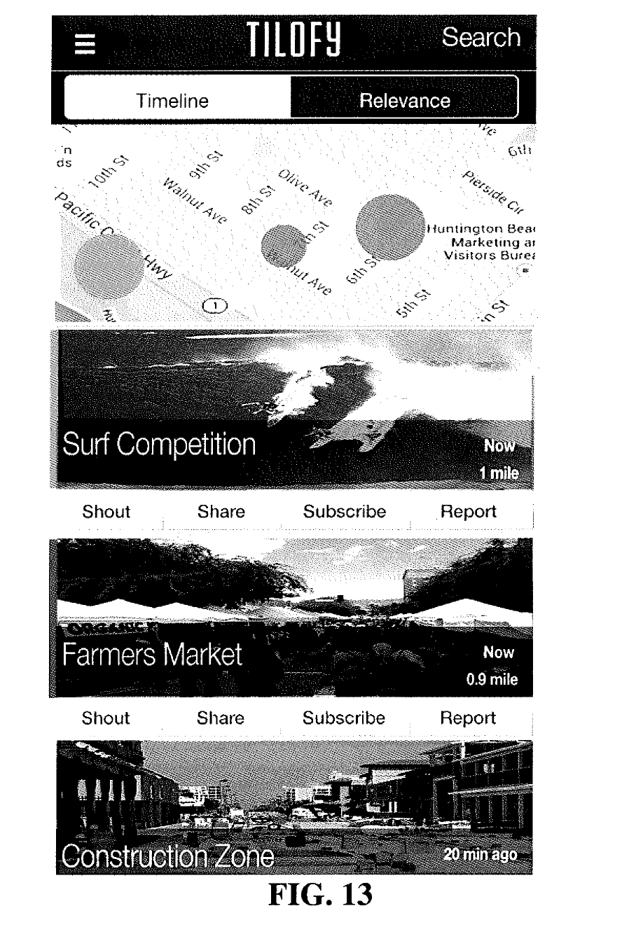

As another example, FIGS. 12-13 illustrate a simple search for “fun and food now near Huntington Beach, Calif.,” where various heat-map illustrations may correlate to found results, displayed illustratively below the map view. A user may then select individual results to see more information (articles, documents, etc.), or else may perform other actions, such as “shout” (described below), “share” (social media, direct messaging, etc.), “subscribe” (described below), or “report” (e.g., flag as inappropriate or incorrect).

Note further that according to certain embodiments herein the time may be searched without a specific location, and the location may be searched without a specific time. In addition, the time and/or location may be searched (together or independently) without a searched topic, such as the option to show all available stories about San Antonio, Tex. between the years 1800 and 1900 (notably not “from” 1850, but rather “about” 1850), or all available elements from science stations in Antarctica, or all available elements from the 5th to 10th Centuries AD. Granted, the user may further refine the search to include additional (or more specific) times or locations, as well as search terms, based on the preliminary results.

Notably, though a time (or location) need not be searched initially, the results may still be displayed based on time (or location). Other techniques for sorting the results may also be used, such as through various boosting/ranking algorithms (e.g., linkage, proximity, recency, social activity, etc.). For example, in one example embodiment, the techniques may use what's called a “Klout score”, which is a numeric measure of someone's online reputation or importance. Also, in another embodiment, the techniques may cross-reference the platform's data with what's trending on other platforms to boost results. Further, the platform herein may segment and/or link results based on gender, age, interest, etc. so different users see different rankings. Additionally, the concept of using data generation velocity (how quickly data is being generated for a given topic, such as the number of TWITTER TWEETS regarding a concert, plane crash, etc.) may also be used in the boosting/ranking algorithm.

Note further that while the time and location indicated within a query (e.g., a searched-for time) may be stored for use as saved searches or for subscriptions as described below, the user's actual physical location and time may also be captured and stored by a centralized database for use as also described below. In particular, various types of search-like interactions are available, such as an explicit search (particular event/time/location), exploration (“browsing”, following “paths” or “leads”), subscription-based queries (described below), or sharing (“shouting”, described below).

Note that although location is generally at the heart of the techniques herein, it is not explicitly required. For instance, in one implementation, location might not be a required input for discovery, such that users may be shown what's happening in real-time in different locations across the world in real-time. In addition, and perhaps more importantly, location need not be required for search. This is a use case where users search for a particular topic (e.g., Christmas, Obamacare, etc.) and the system herein presents them with locations where things are being discussed. Clicking on each location region (e.g., in a map, list, etc.) may take users to all conversations/documents in that specified region related to that topic.

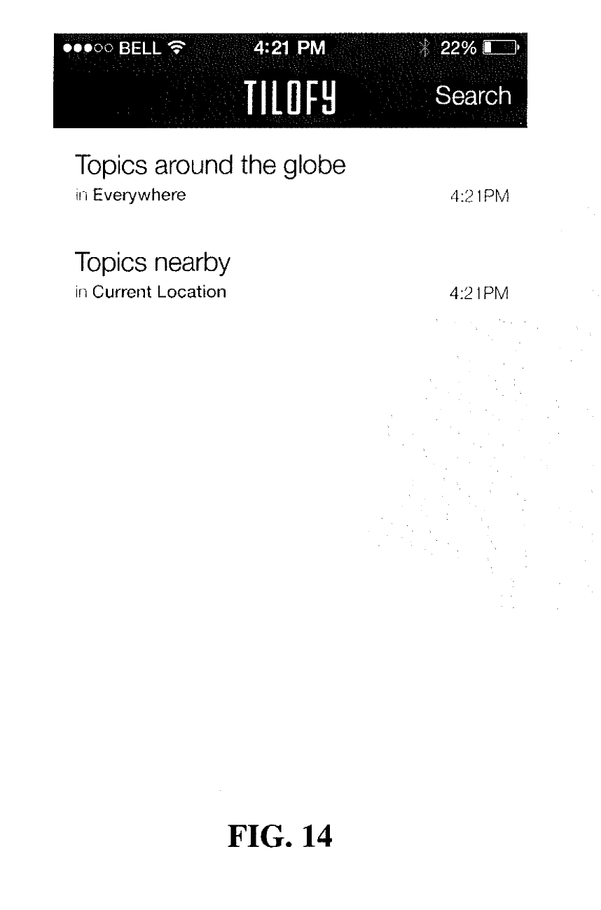

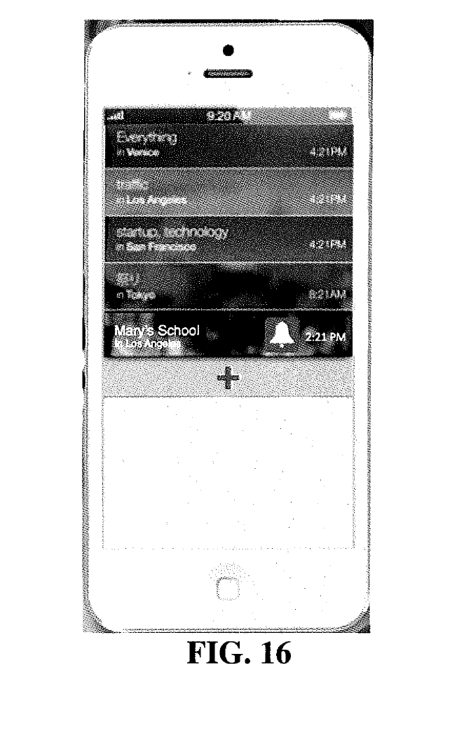

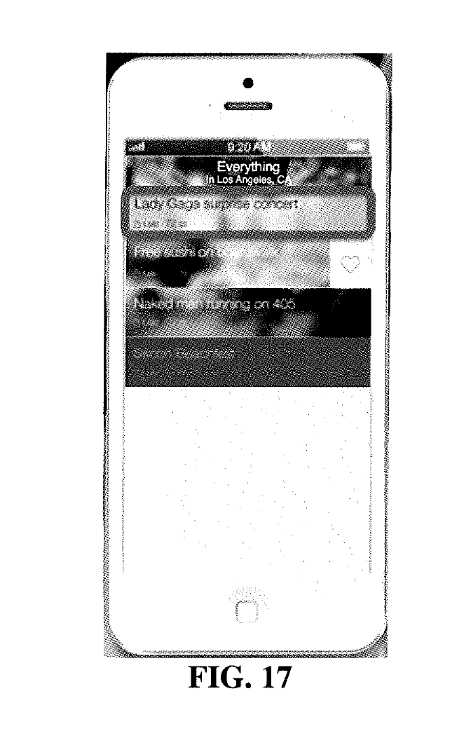

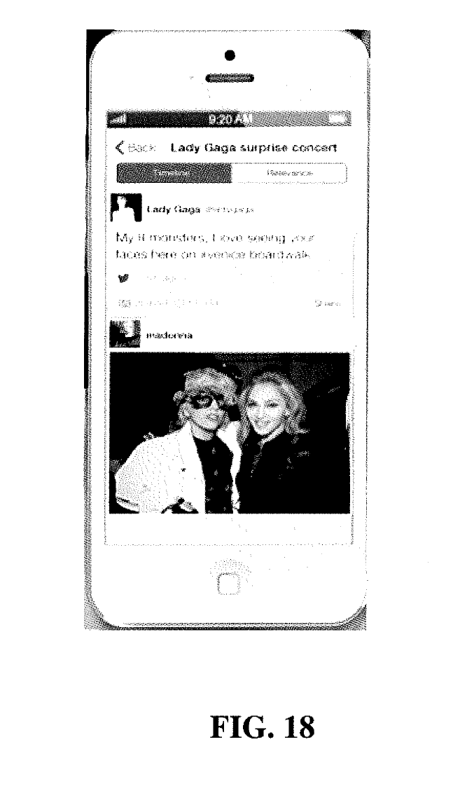

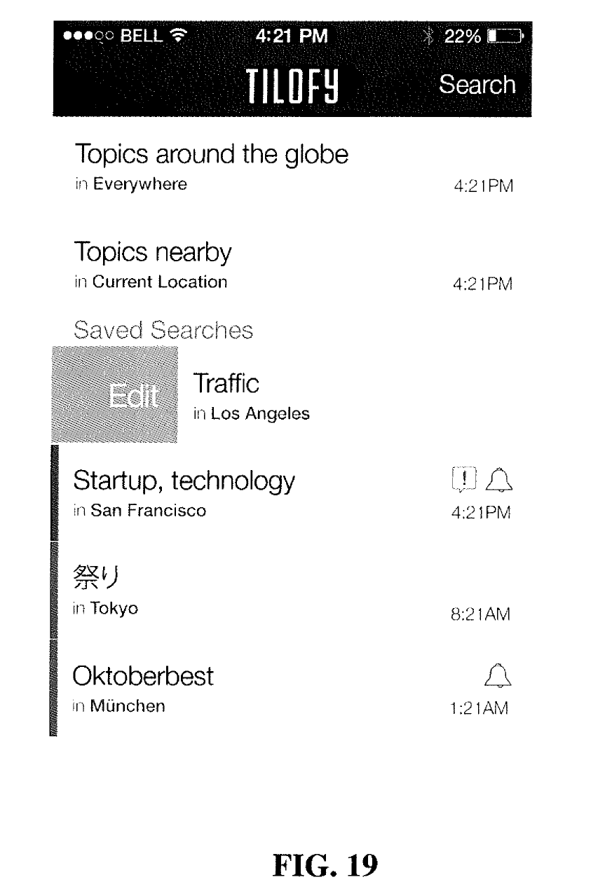

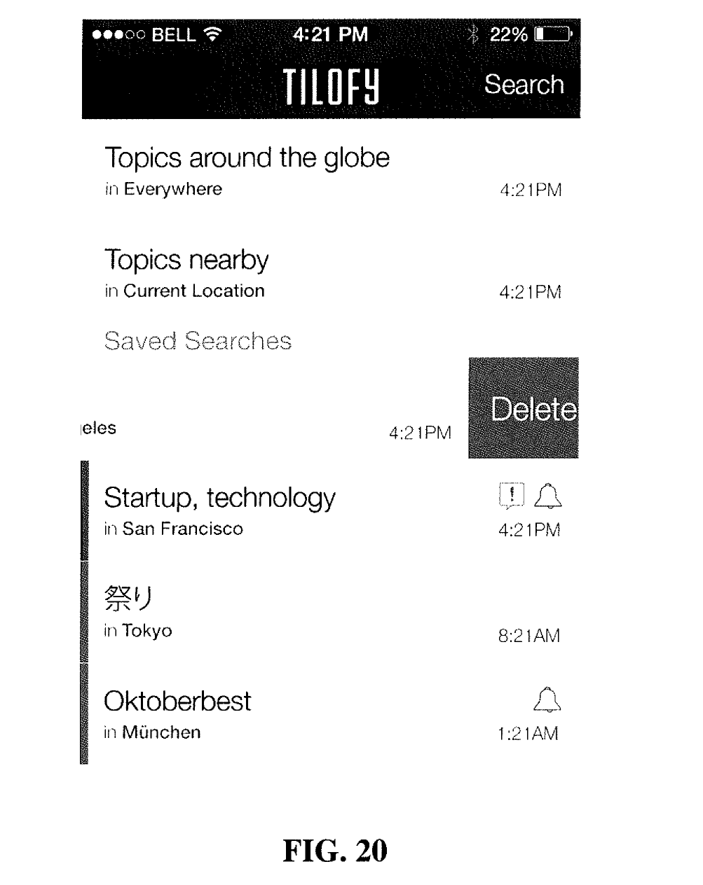

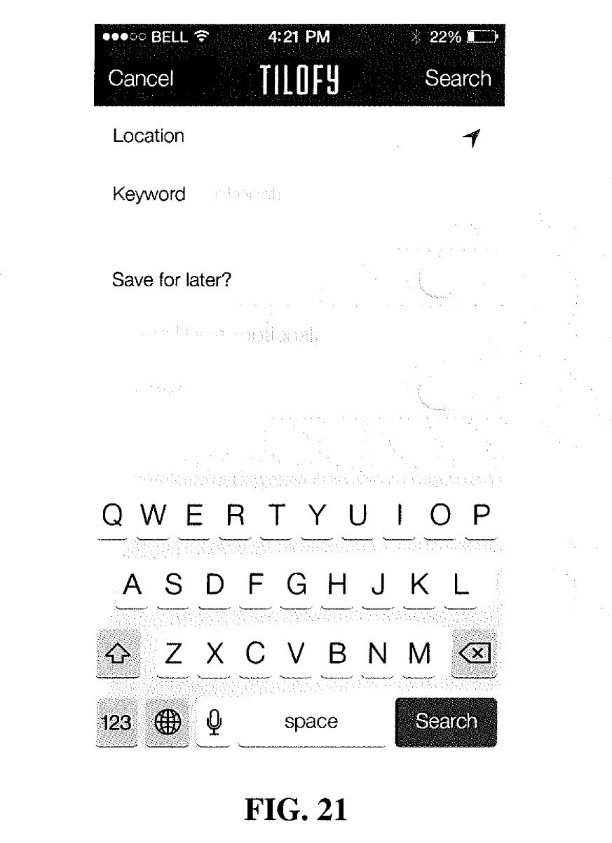

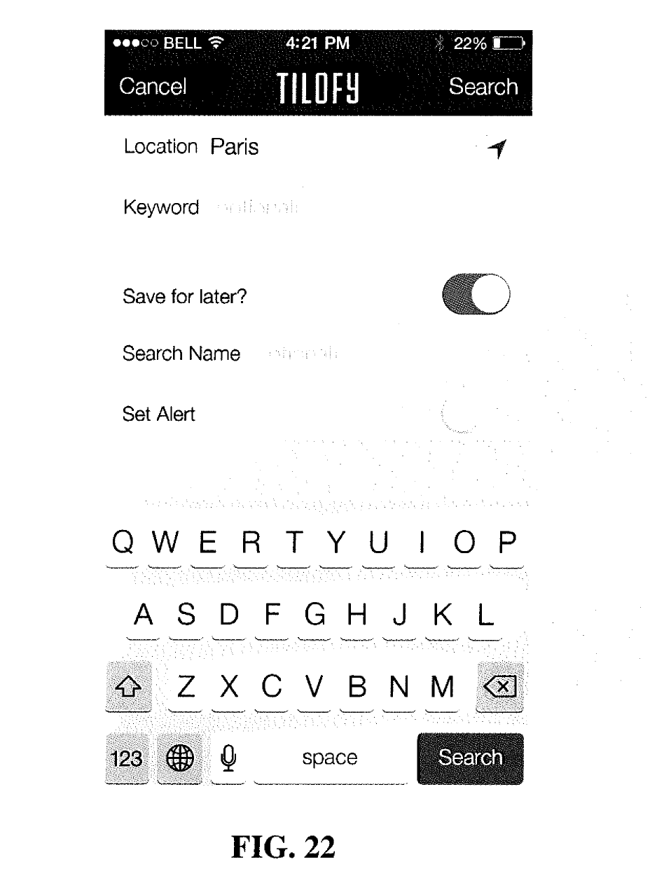

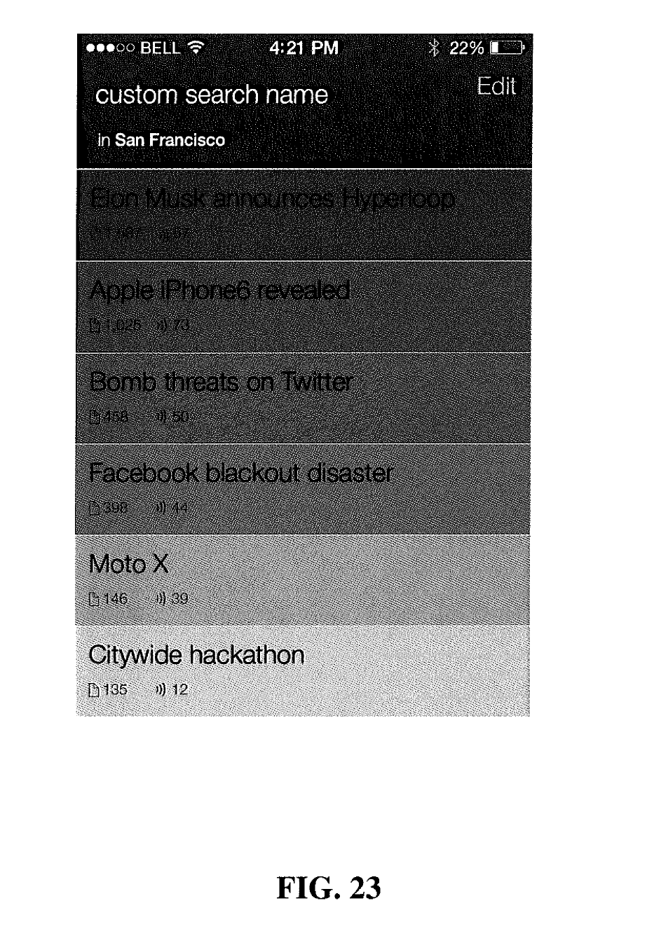

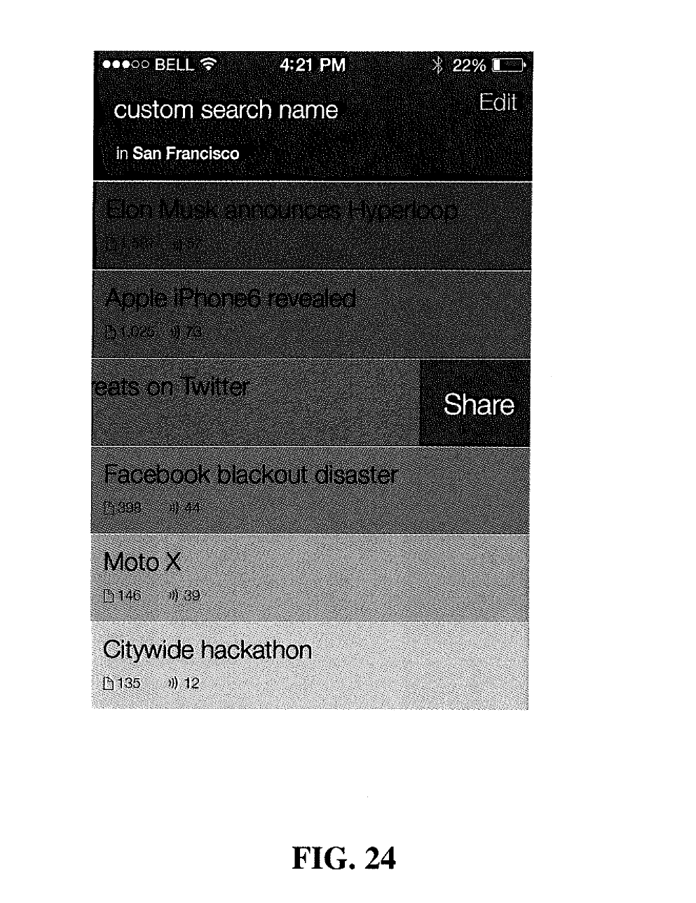

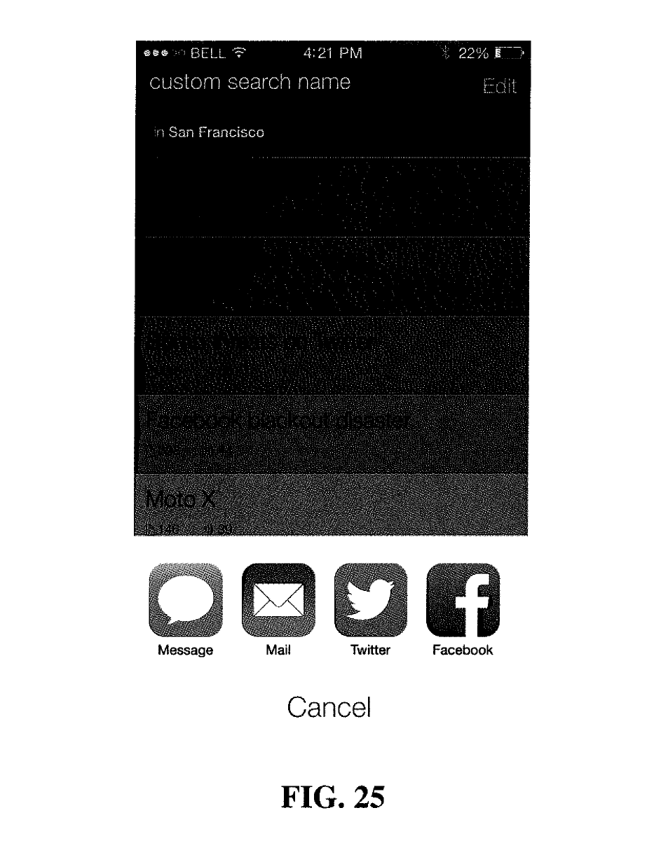

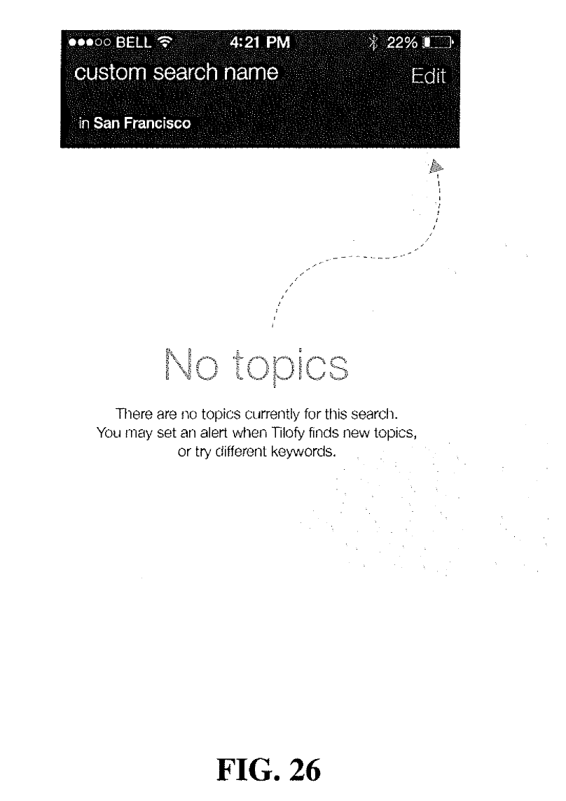

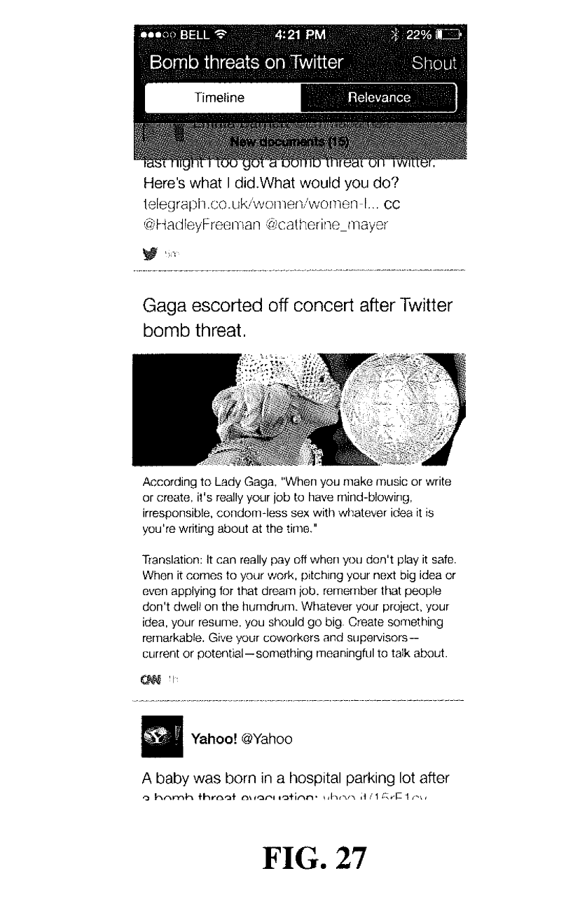

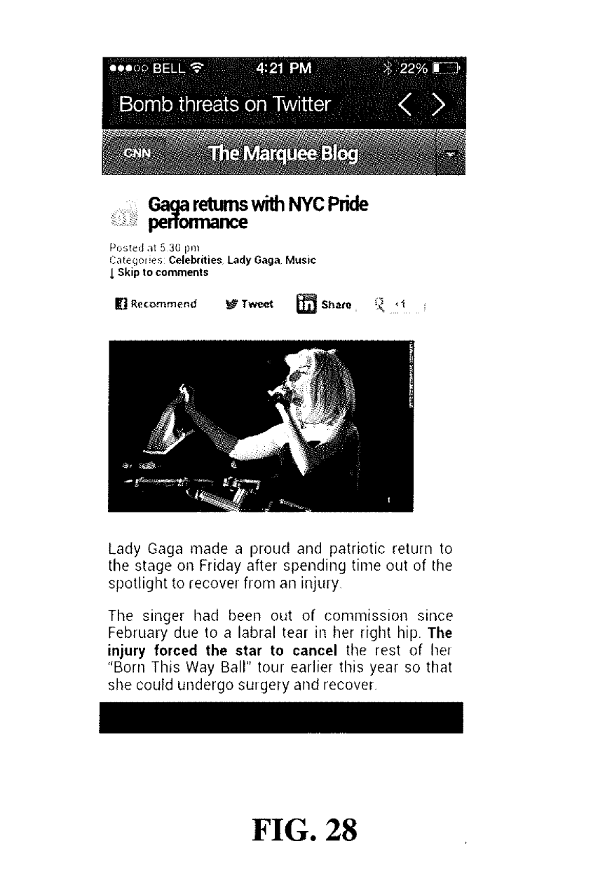

FIGS. 14-28 illustrate example screenshots of an illustrative implementation of one or more embodiments according to the techniques described herein.

Subscription

According to one or more embodiments herein, users may “subscribe” to a particular search, such as naming a particular location, where the “time” is the future. For example, people might be interested to learn anything posted about a particular school, neighborhood, region, etc. In addition, this concept may be extended to topics as well, such as “free food”, which may be associated with the user's current location (as the location moves), or with a particular specified location (e.g., near the user's school or home). In other words, according to the spatio-temporal subscription system described herein, a user can subscribe not only to a region, but may also optionally filter results according to a particular time, a particular set of categories, a particular set of tags, a particular set of users (e.g., posts from celebrities, news anchors, media outlets, etc.), a particular topic, and so on. In this manner, a user may receive instant alerts if any new element appears online that relates to the saved search, particularly for a given location.

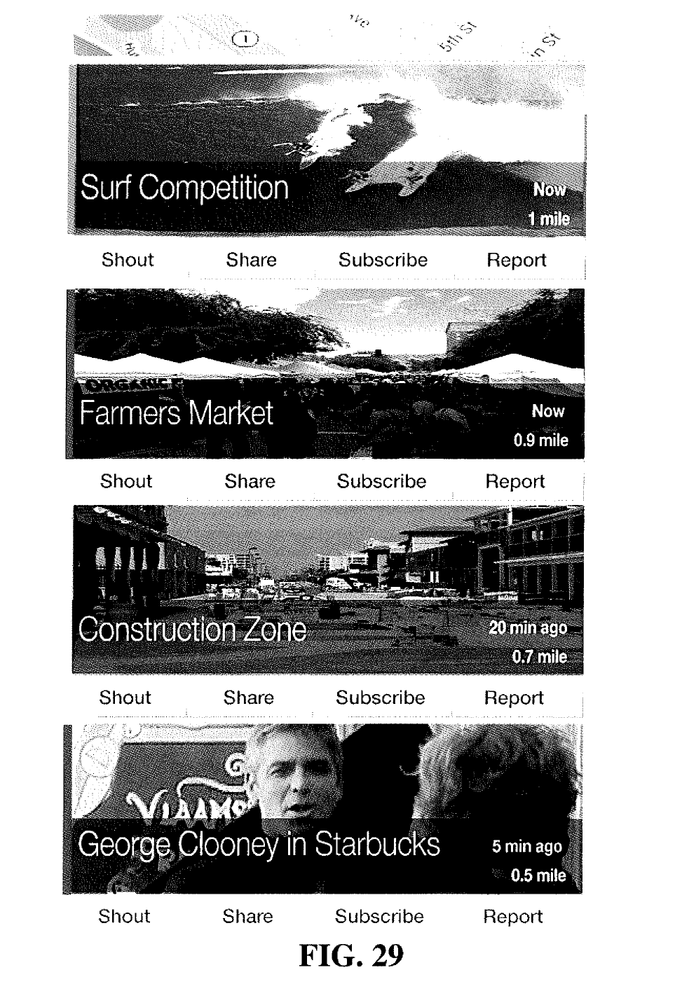

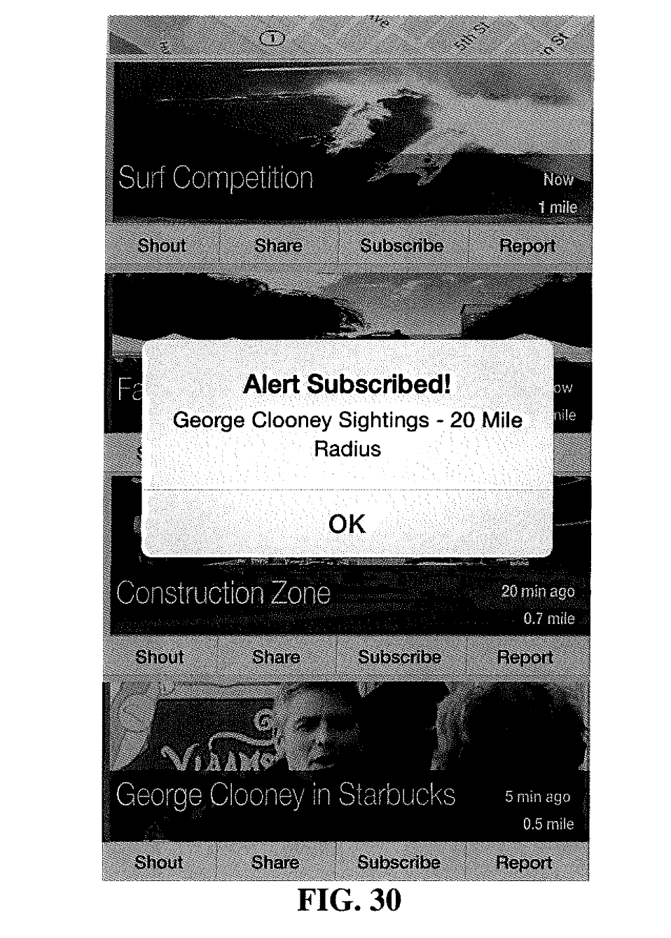

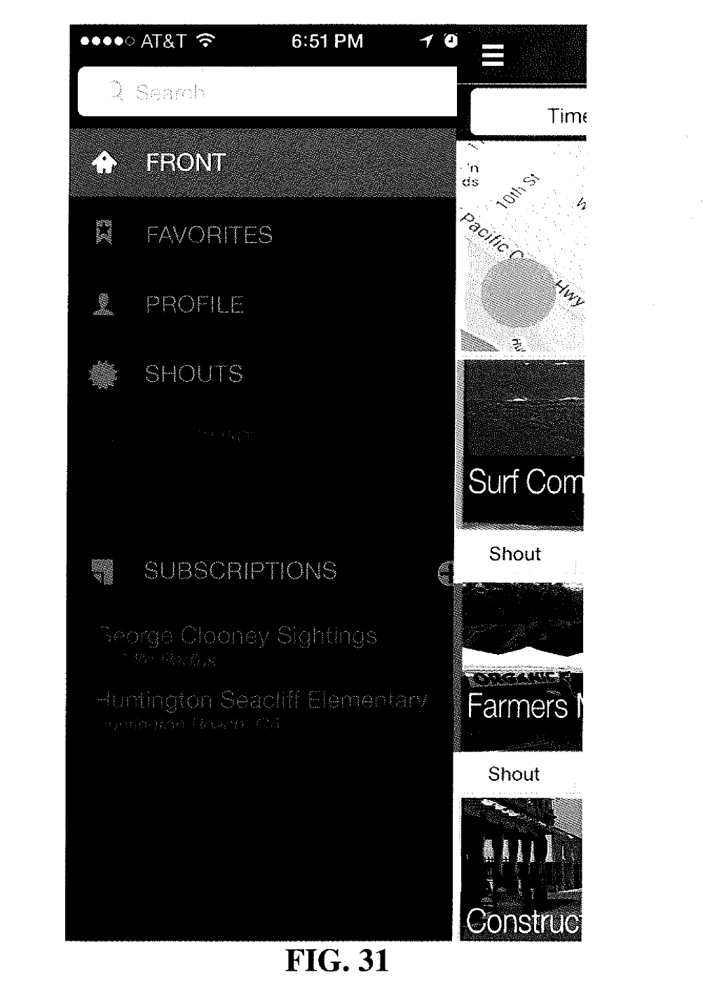

For example, in addition to manually entering a particular search topic to subscribe to, in an alternative embodiment as shown in FIGS. 29-30, assuming that (as in FIGS. 12-13 above) an additional topic result was a celebrity citing nearby, a user may then select the “subscribe” button and may be subscribed to receive alerts when a new result (event, article, report, etc.) occurs that is categorized under that same topic (e.g., a particular celebrity nearby). A listing of all current subscriptions may also be available for viewing and management by a user, such as shown in FIG. 31.

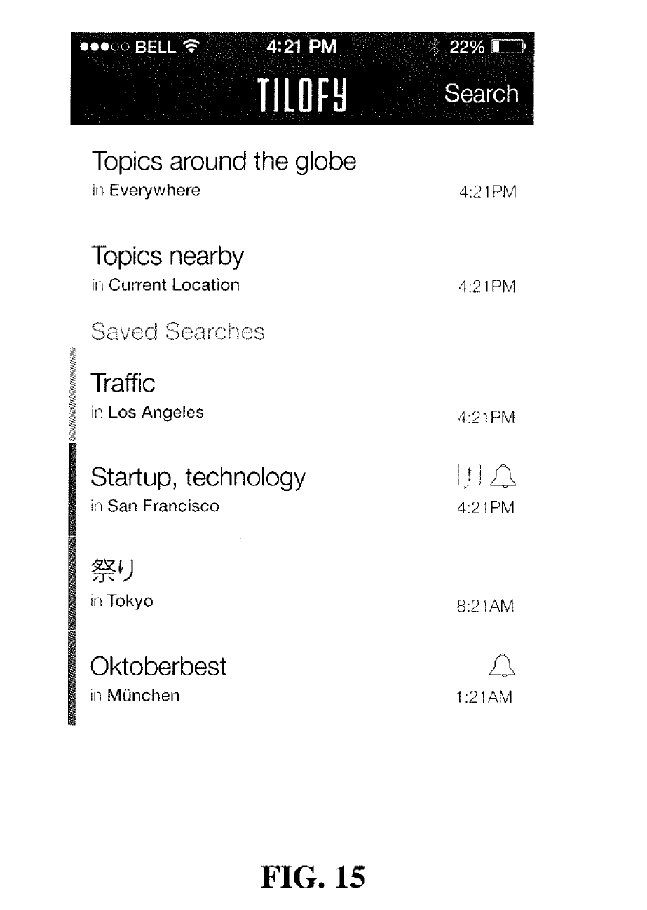

Note that other means of expressing location as mentioned above, such as “happening near regions/spaces I care”, “happening in my neighborhood”, “near where my kid goes to school”, etc. may also be used for subscription-based services herein. (Note also that for the saved searches page (FIGS. 14 and 15), the “location” parameter could be “places I have been today/this week/this month/etc.”, allowing a user to later “catch up” with whatever happened earlier without having subscribed to it already.)

Shouting

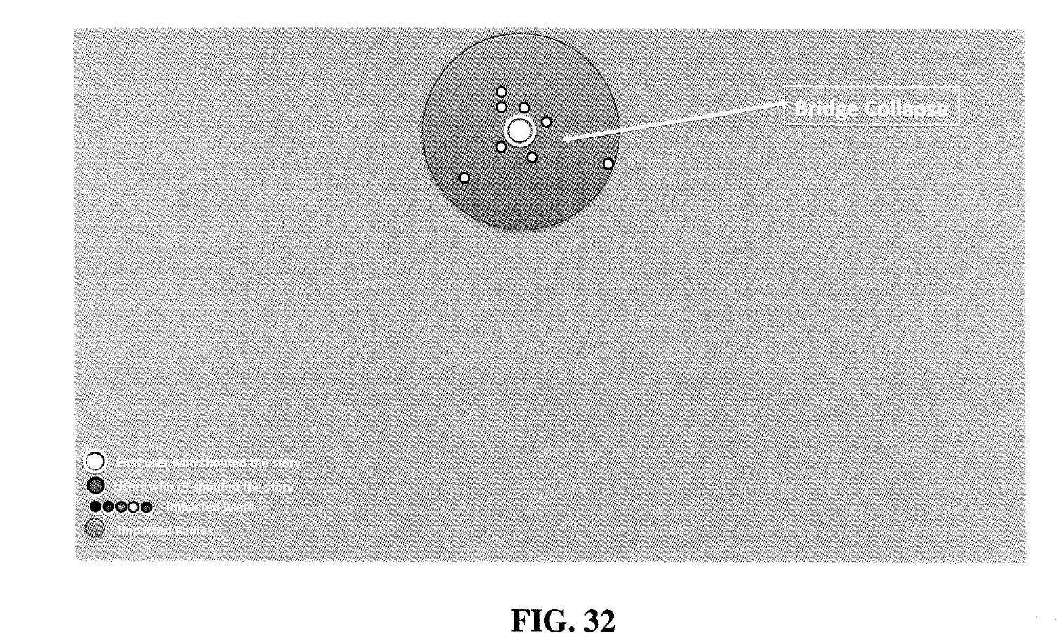

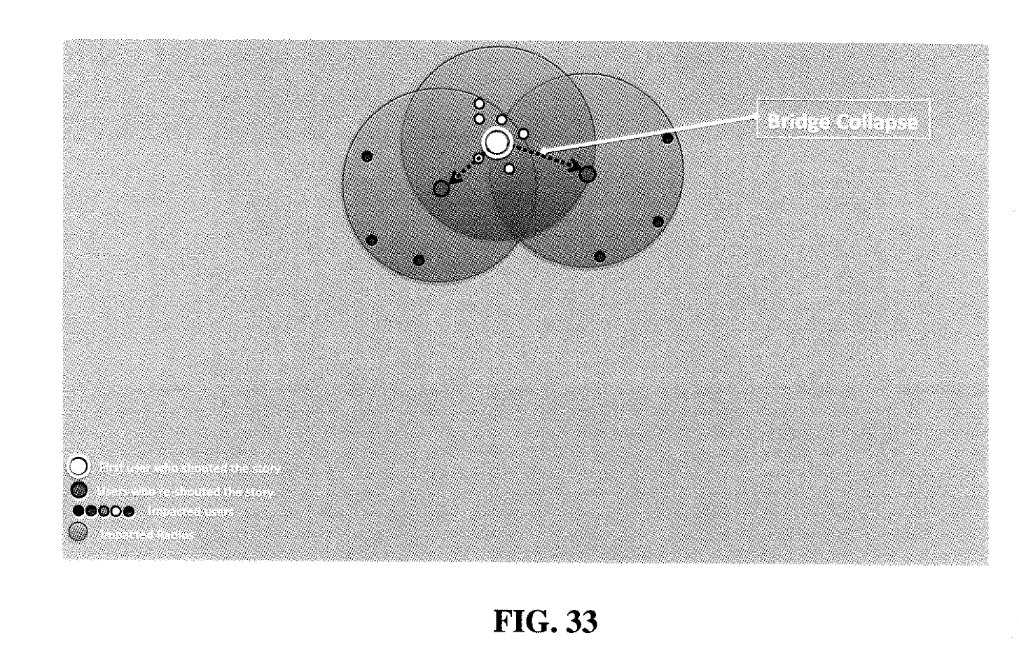

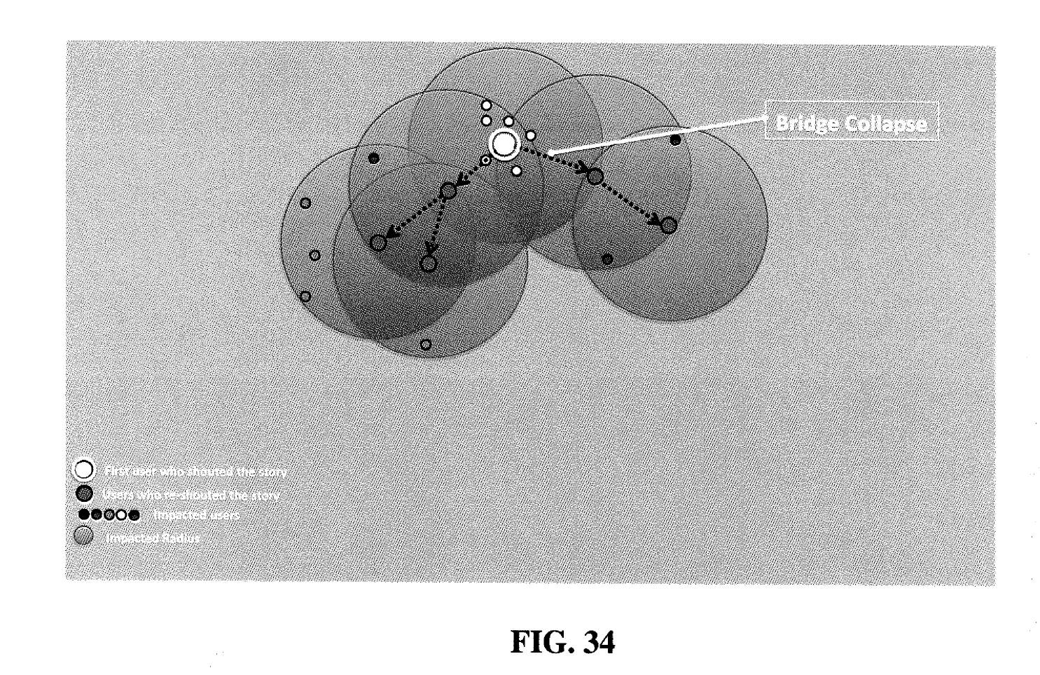

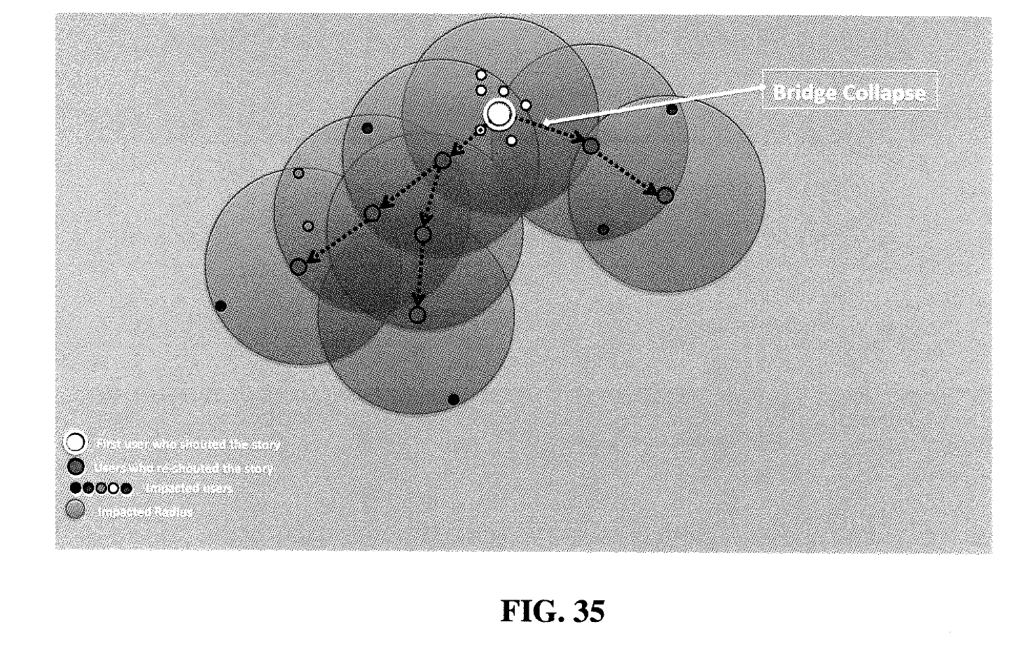

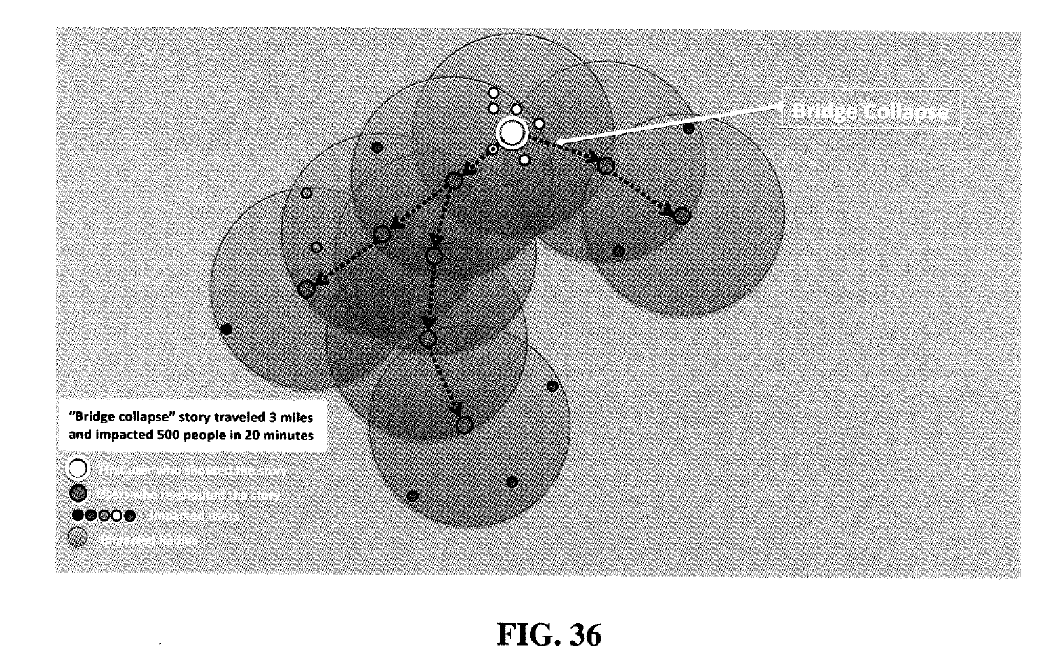

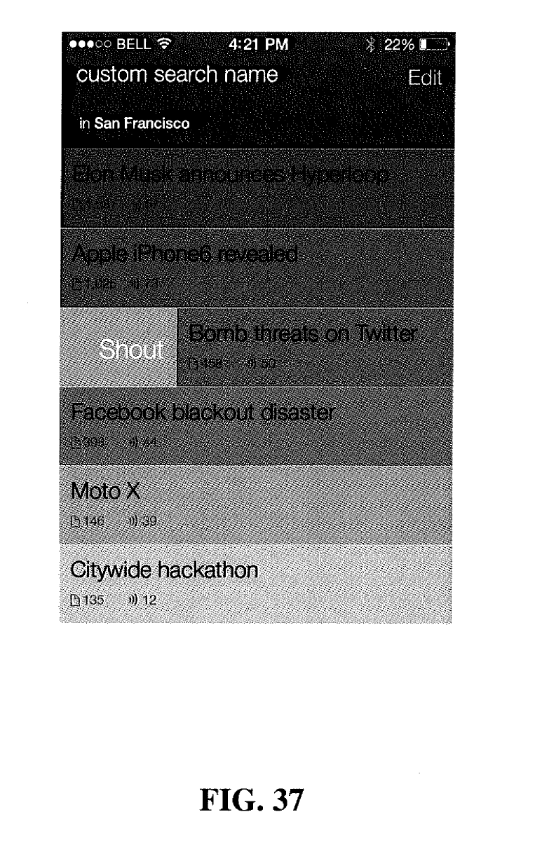

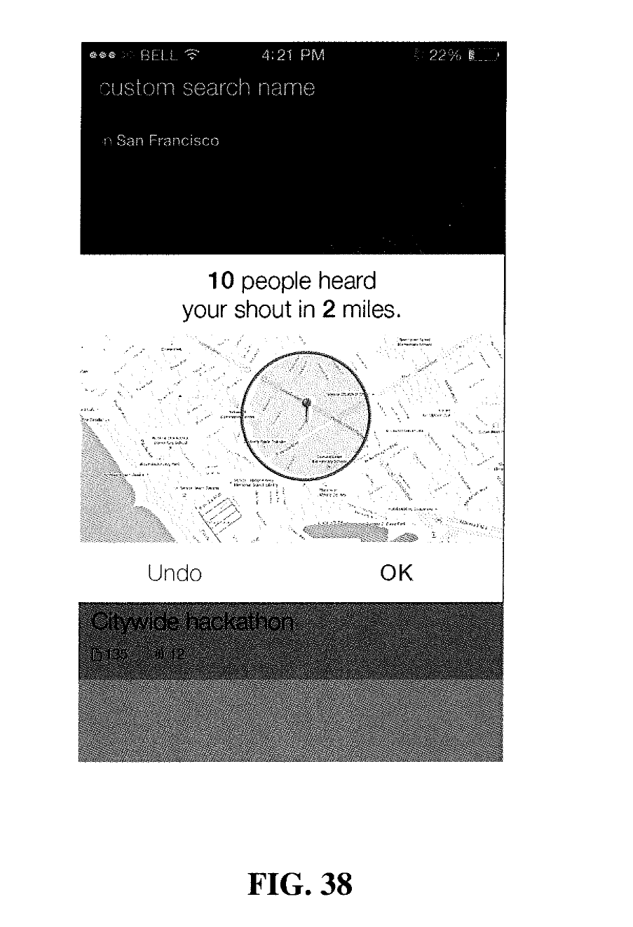

According to one or more embodiments of the present invention, “shouting” is the concept of online sharing a particular piece of information or topic (with a plurality of related information) to a surrounding area/region (e.g., a re-posted or originally posted element). Similar to vocally shouting, a “shout” herein allows users to share information with other users located within a certain (configured or user-defined) radius/area/region. For example, and with reference generally to FIGS. 32-38, assuming a particular event happens, such as a parade, fire, traffic, road closure, celebrity sighting, and so on (e.g., a “bridge collapse” in FIG. 32). Assuming a user would like to share this information with other users within a given proximity (who have allowed receipt of shouts, and/or who are within a particular set of users, such as “friends”, “followers”, or the general population of platform users), that first user may “shout” the information, which may reach one or more other users (e.g., nearby users) who may or may not be interested by the topic or information that is being shouted (e.g., other users that are currently driving near the bridge collapse). As shown in FIG. 33, certain users may re-shout the information (again, re-posting the same information or generating their own content), at which time the impacted region expands to the areas around the re-shouters. This may continue until re-shouting stops, such as where the incident is no longer interesting/impactful. As shown from FIGS. 34-36, for example, there is a noticeable “path” of the shouting, which may demonstrate the location of a major highway affected by the bridge collapse, and people wondering what is happening.

An example algorithm that may be used to decide whether something is still impactful is as follows: If a topic T, has not been re-shouted more than X number of times, within a region of at least size R miles, in a time period of T, with related number of documents less than D, with related social ranking less than S, it will be considered non-impactful. (Note that any subset of the above parameters could be used by the system herein to intelligently determine the “cut-off” line.)

The concept of shouting as defined herein is greater than simply re-posting a singular piece of information. That is, shouting is a process to move a piece of data from one location to another location on any computing and displaying device. The shout could be automated or crowdsourced to echo a piece of data in the physical world and move it from one digital device to another one. Although the topic gets spread in a physical location, users will be informed of the original location where the topic is generated (and optionally the shouting users identity, or else being shouted anonymously). Notably, when a single element is important (e.g., a TWEET about a plane crash), that one element may conventionally be distributed (e.g., RE-TWEETING). However, according to the techniques herein, the entire real-time conversation about a given topic (e.g., other TWEETS, photos, news articles, etc., about that plane crash) may be distributed.

Note that in one embodiment, the shouts may be “pushed” to other users, meaning a notification or other indication may be sent in an unsolicited manner to users, or else those other users may specifically search for shouted information (e.g., by simply looking for what is happening near them, now, according to the techniques described above).

Furthermore, it should be noted that the shape and distance of the “shouting” reach could be arbitrary or constructive, and the speed and directionality of the information flow (e.g., a Doppler effect) may be learned and used for filtering of events, both for the current event at hand, as well as for behavior-based models in the future (e.g., who cared about what, and how far away, etc.).

Note also that one of the key advantages of shouting is to use it as another important input for ranking the results returned for each user. That is, shout data may be used, along with user context, to further refine the search result ranking as described above, such as to produce “hot topics”.

According to one or more techniques herein, the concept of shouting may also be useful in a number of manners aside from mere information dissemination. For instance, it is thus possible to track how many people are affected by a topic, as well as in what time/rate they were affected. Further, the arbitrarily shaped path along which the topic is affecting users at a particular “growth rate” can be determined, which may be used by many data processing algorithms, including as an input to the ranking algorithms described herein.

Business Models

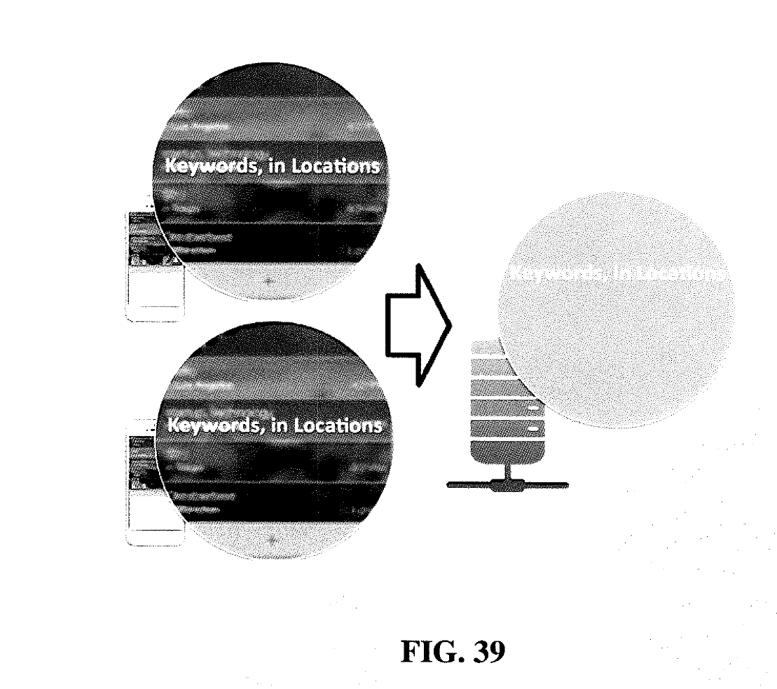

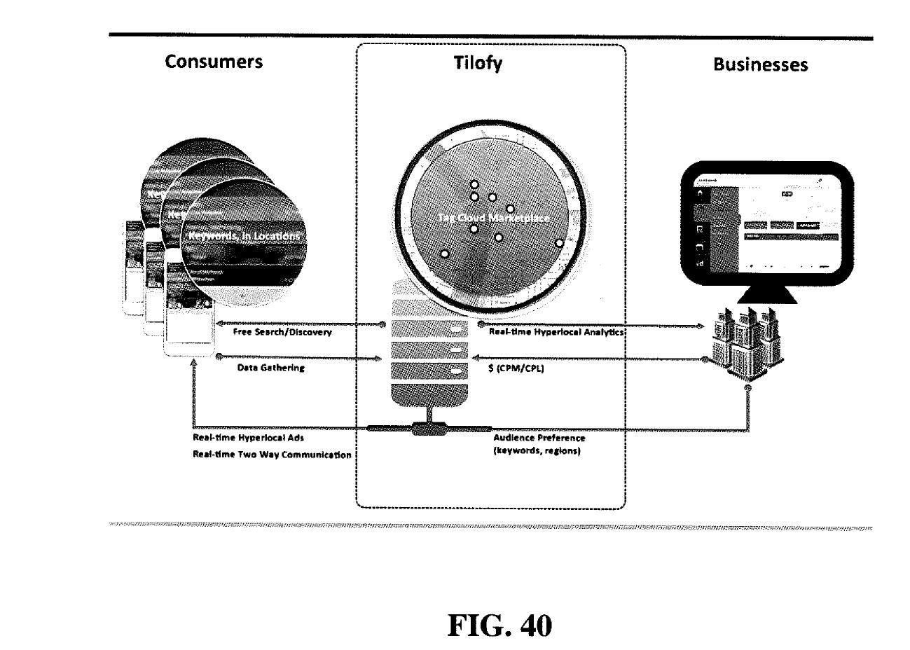

With reference generally to FIGS. 39-40, various technological advances that are beneficial to business may be established according to the embodiments herein. For instance based on users keywords, interests, locations, subscriptions, shouts, travel paths, etc., by storing these information points in a centralized server, businesses may be armed with valuable information. For instance, starting from consumers, producers may choose marketing-based tags real-time based on current interest (e.g., people are searching for a particular brand of automobile, or a particular genre of food, in a particular region, during a particular timeframe), whether from real-time (current) searches, saved searches, subscriptions, or tracked searches. Conversely, starting from producers, the system herein can be configured to provide services to businesses to monitor/embed location/time specific data on their platforms. For example, a variable pricing scheme based on proximity in space and time may be provided to a particular retailer, as described below. Other marketing targets may also become readily available, such as targeting users based on preferred/subscribed regions (e.g., home, vacation spots, work, etc.), as well as based on location trajectory (e.g., driving into a particular region, how often the region is visited, etc.), or other insightful correlations made available by the topic generation engine described herein.

For example, in addition to the data collection regarding the time (e.g., day, week, hour) of particular keyword searches (e.g., “free food” after midnight in the city), other more intelligent uses of the information obtainable by the embodiments herein may also be available. For instance, the concept of a “Tilo” herein is a time and location specific “channel”, where content may be published based on user interest. For example, in addition to user-based searching for information, channels may be pushed to users based on their current location, such as, for example:
At a circus: “The lion show will open in five minutes”;
At a restaurant: “Here's a link to watch a video of the chef cooking your meal”;
At a show: “Click here to see backstage images”;
At the movie theatre: “Go here to download the soundtrack for this movie”;
At a retail store: “Try our new app now that you are here”.

Similar to topic title generation, the techniques herein may generate location-specific temporary location identifiers for channel identification, which may then be presented to local businesses for various marketing purposes. For instance, in one embodiment, a business may register a promotional campaign for a particular region during a particular time, such as “Italian food” for Friday night. Whoever searches for “Italian food” (or similar search) on Friday night will be directed to the registered business(es). Additionally, according to the techniques herein, knowing which search terms (tags, topics, etc.) to register may also be beneficial, based on historical data collection. For instance, if businesses can discover that Friday night and Saturday night are the biggest nights for searches on “movie playtimes”, then they may be willing to pay a premium to register their business according to that search term in Friday and/or Saturday night, rather than on Wednesday night. As another example, a business may register a given search phrase or word, such as “birthday”, such that any searches for that word (e.g., alone or in combination with other words, such as “birthday party” or “birthday supplies”), results in direction of a user to that particular business.

The following explanation may provide generalized clarity: Assume a business purchases one of these keywords for a region, during a particular time frame. There are two ways this keyword purchase can be used by the platform described herein. One is users searching normally in an associated platform app and getting to see the business' promoted information along with the organic topics or conversations. But the other way is to have a dedicated/separate use-case for searching these keywords. In this second case, users are not performing normal searches as explained above. Instead, they open the app for a different purpose. They are at a convention, concert, etc., and want to very quickly get to a certain channel or “Tilo”. They might press a button on the app which prompts them for this ID and pressing the ID takes them directly to that channel. In this scenario, contrary to the above one, the dedicated ID is used like a promoted hashtag by TWITTER, except that it's guaranteed to take users to a channel owned or curated by the business. It is also important to note that finding this channel is considerably easier than memorizing a hashtag. That is, because a user is presented with the channel ID immediately because of his/her current time and location context, there is no need to memorize a hashtag.

Note that compared to other unique IDs, URLs, Handles, etc., these IDs may be unique during a given time frame at a particular region. In other words, with conventional applications, when someone owns a URL, a handle, username, prompted page, etc., it's theirs such that regardless of when and where people search for it, they are taken to that page. In contrast, according to one or more embodiments herein, a business B can “own” the word “free food” on Thursdays in zip code 90802 while “at the same time/in a different location” or “at the same location/in a different time” business C owns the same keyword. Depending on where and when users search for these keywords, they are either taken to B or C's promoted channel. This effectively creates a time and location based keyword/topic bidding marketplace.

In general, the techniques herein may provide information about users current locations, saved locations, frequented locations, searched keywords, times of those locations and/or keywords, and so on, and create a sort of “tag cloud marketplace”, where, for example, “these users in this region have interest in this particular topic (e.g., and at this particular time/s)”. In other words, the techniques herein do not merely provide just current locations, but also current interest. For example, if 5000 users are searching for “TV sale” in Santa Monica from Tuesday through Friday of a given week, then a business may decide to run a promotion on the weekend for TVs, and may also decide to inform the searching users (past and/or future) of the sale.

Future interest, in addition, is also made available by the techniques herein, such as based on subscriptions as described above. For instance, if someone is vacationing to Maui in February of 2014, a subscription may have been made by the user, e.g., in general (all events/documents relating to Maui that are posted), or for that specific future date (e.g., only interested in events/documents relating to February of 2014). If a particular business has, or decides to have (based on the interest), a promotion for that time, it may specifically reach out to the subscribed user to inform them of the promotion.

According to one or more embodiments herein, for example, users may be presented with a “promo” inbox, in order to match business targets to search users. For instance, using the inbox, business may “gently” push promotions to users based on the user's time and location preferences, their search keywords, etc. These promotions may be real-time, and may be added to (e.g., a first promotion message, followed by a second, third, etc.), or else edited within the inbox (e.g., replacing the first message with the second, etc.). The additions or changes may be based on time, location, trajectory, etc. For instance, as a user approaches a store's location, a 10% sale coupon may appear in the inbox, but while travelling away from the store's location, a 20% sale coupon may appear. Note that such targeted advertising services may be presented to businesses as part of a premium mode of operation.

In general, the promotions may be based on a user's current location, their preferred locations, their daily route/path (e.g., a work commute), or a vacation route. Note that it is also possible to adjust the promotions (e.g., the actual promotion, the receipt of the promotion, etc.) based on the frequency at which the user is at/through location, such as offering commuter discounts if a user passes through a location daily, versus offering a one-time discount (or not reaching out at all) to a user who is only seen in a particular location a low number of times (e.g., once, passing through). In addition, user's general trajectory may be used, such as to determine that a user might be headed toward a major city for dinner time or for a weekend, and certain promotions for that particular city/location may be presented to the user (e.g., a user traveling toward Las Vegas on Friday afternoon from Los Angeles might be presented with various deals or marketing pieces for Las Vegas for the weekend, prior to the user actually arriving in Las Vegas). Notably, the items in the promo inbox may be kept and/or purged based on the frequency of visiting the location as well. For instance, if the user frequents Las Vegas, the items may remain in the inbox, but if only visiting once within certain length of time, the inbox may remove the items related to Las Vegas.

Another marketing feature made available by the technology described herein is differentiated services for business based on whether they are large or small businesses. For example, not only can users be targeted based on given context, such as anyone in this region interested in this topic (e.g., TV, free food, etc.), but business may also be alerted of the presence and/or count of these users. For example, smaller businesses may subscribe to services provided by the system herein to be alerted if a single person is interested in a given topic (e.g., “antiques in New Hampshire” or “fishing trips in Miami”), while alternatively, larger businesses might be configured for being alerted when only a certain threshold number of users are interested in a given topic, such as over 100 users searching for TV deals in Portland, Oreg. Specifically, since mass marketing can be costly for smaller businesses, and likewise focused marketing can be costly and time-consuming to larger businesses, the techniques herein allow for the fine-tuning of marketing strategy. Small businesses may be notified when individual users are interested in a given topic and near their general place of business (e.g., and at a particular time/time interval), and the business may then start up an actual one-on-one conversation with the users. Conversely, the large businesses may have pre-made advertisements ready for publication, but only release the advertisements when, say, 500 people are all looking for the same thing (e.g., if certain triggers are determined, such as search terms, locations, times, etc., automatically push an advertisement to all users who match this criteria to all users in general).

Still other technology-based features are made possible by the techniques herein, such as providing differentiated services to businesses based on tailored subscription levels, such as being able to stay within the promo inbox longer, appearing at a different order within the inbox, appearing in a different order based on location and/or time (e.g., users within a five-miles radius versus a ten-mile radius, or users searching only on Friday versus users searching anytime), trajectory, number of times through a location (e.g., once a user is known to be in location more than three times, versus being able to market to that user the first time they are in that location), and so on.

Illustrative Flow Charts

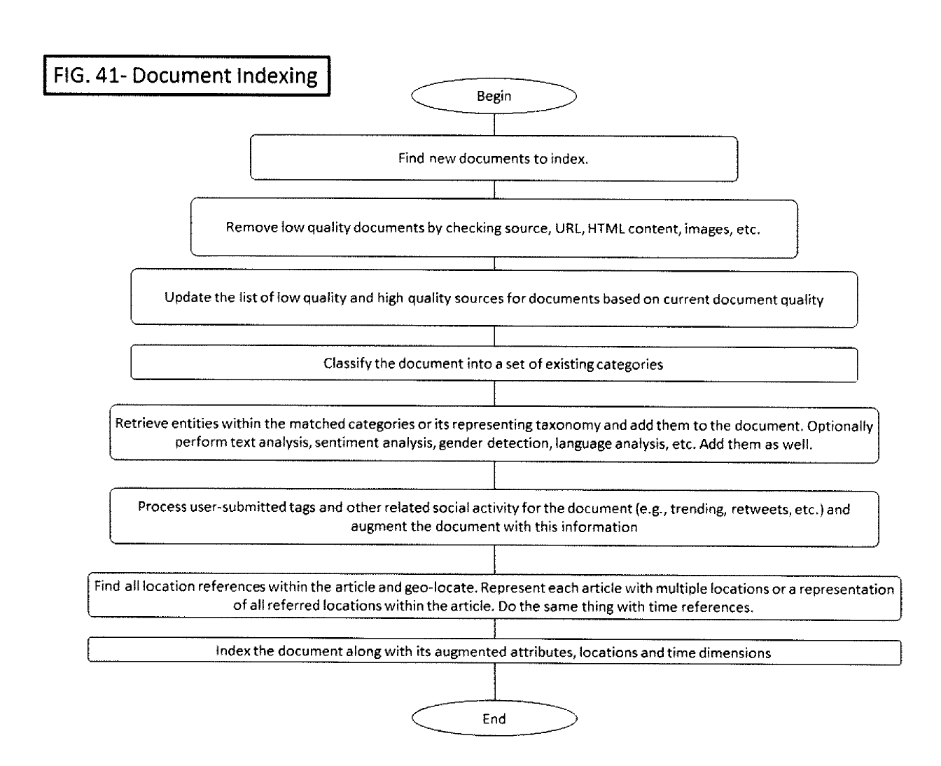

FIGS. 41-55 illustrate example simplified procedures in accordance with one or more embodiments described herein. Note that these procedures are illustrative, and not meant to be limiting to the scope of the disclosure herein.

FIG. 41 illustrates an example simplified procedure for document indexing in accordance with one or more embodiments described herein. For instance, first the system finds new documents to index, and then may remove low quality documents by checking the source, URL, HTML content, images, etc. The list of low quality and high quality sources for documents may also be updated based on current document quality. Once documents are classified into a set of existing categories, the system may retrieve entities within the matched categories or its representing taxonomy and add them to the document. Optionally, the system performs text analysis, sentiment analysis, gender detection, language analysis, etc., which may be added as well. User-submitted tags and other related social activity for the document (e.g., trending, RE-TWEETS, etc.) may be processed, and used to augment the document. Also, the system finds all location references within the article and geo-locates. Note that each article may be represented with multiple locations or a representation of all referred locations within the article. This is also performed with time references. Accordingly, the document may be indexed, along with its augmented attributes, locations, and time dimensions. The procedure illustratively ends, though may repeat to continue finding and indexing documents (data, articles, etc.).

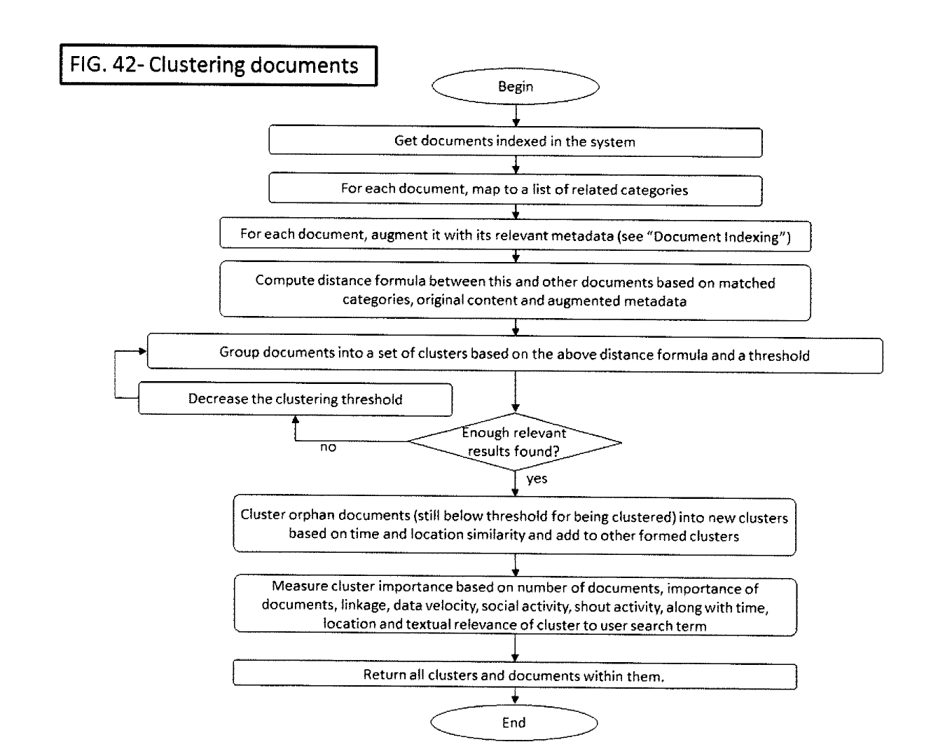

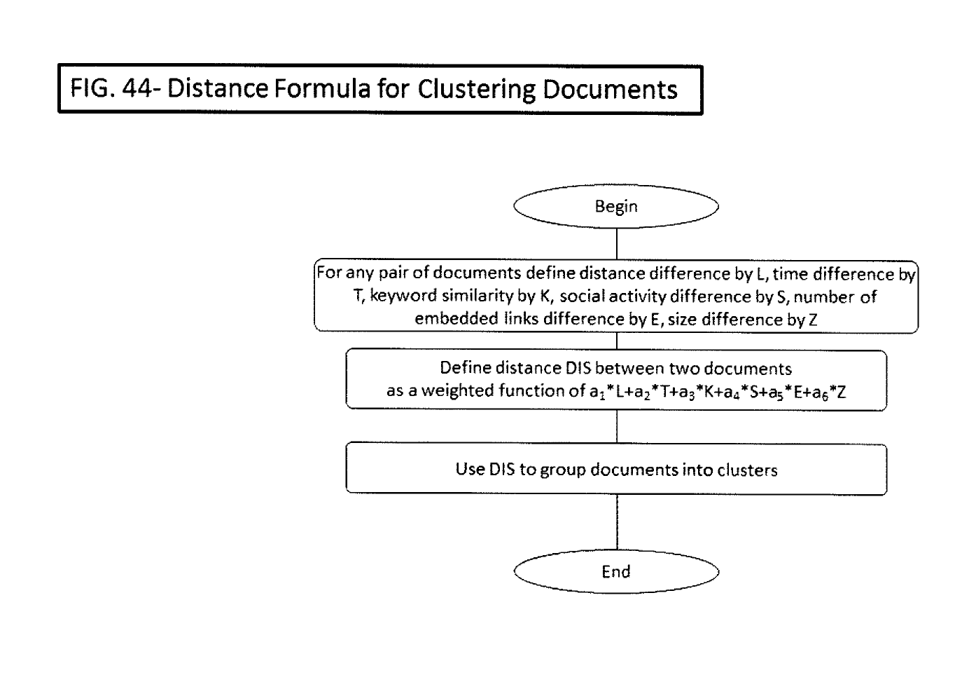

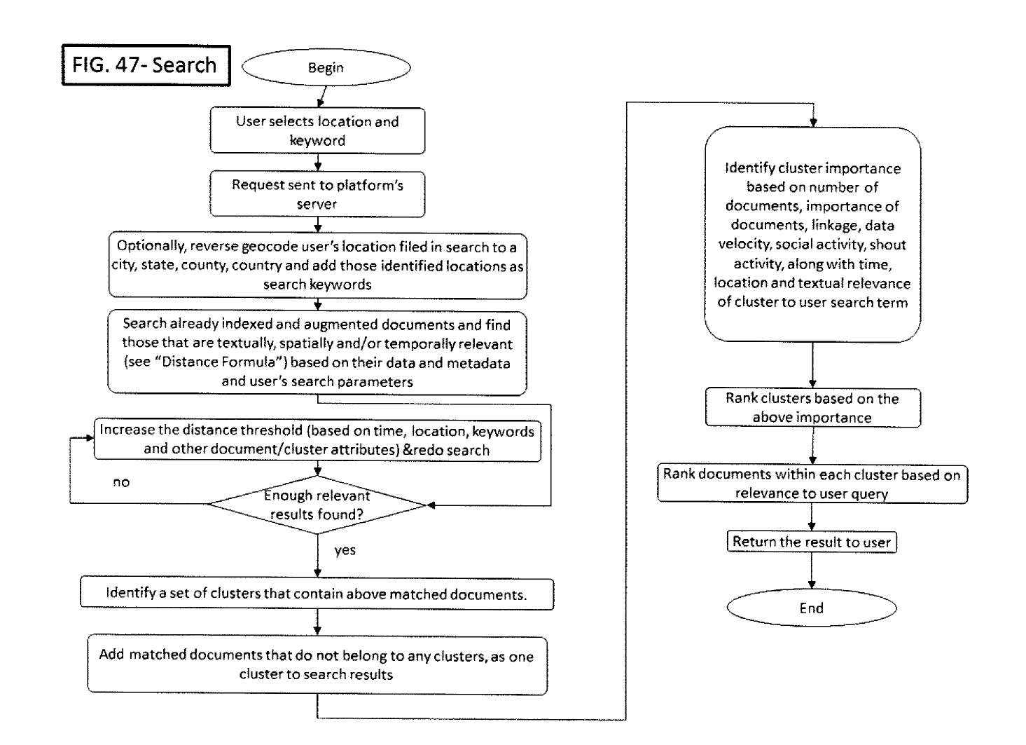

FIG. 42 illustrates an example simplified procedure for clustering documents in accordance with one or more embodiments described herein. Note that clustering may be performed during the indexing stage, or else in direct response to user searches. First, documents indexed by the system (as in FIG. 41 above) are obtained, and then each document is mapped to a list of related categories and augmented with its relevant metadata. As described in greater detail below (FIG. 44), the system computes a distance formula between each particular document and other documents based on matched categories, original content, and augmented metadata, and then groups documents into a set of clusters based on the above distance formula and a threshold. If there are insufficient relevant results found, then the clustering threshold can be decreased to expanding the grouping of documents. Once a sufficient number of relevant results are established within one or more clusters, then “orphan” documents (still below threshold for being clustered) may be clustered into new clusters based on time and location similarity and added to other formed clusters, or else placed into their own “orphan” cluster (e.g., “miscellaneous”). With regard to searching (FIG. 47 below), cluster importance may then be measured based on number of documents, importance of documents, linkage, data velocity, social activity, shout activity, along with time, location, and textual relevance of cluster to user search terms, and then all clusters and documents within them can be returned.

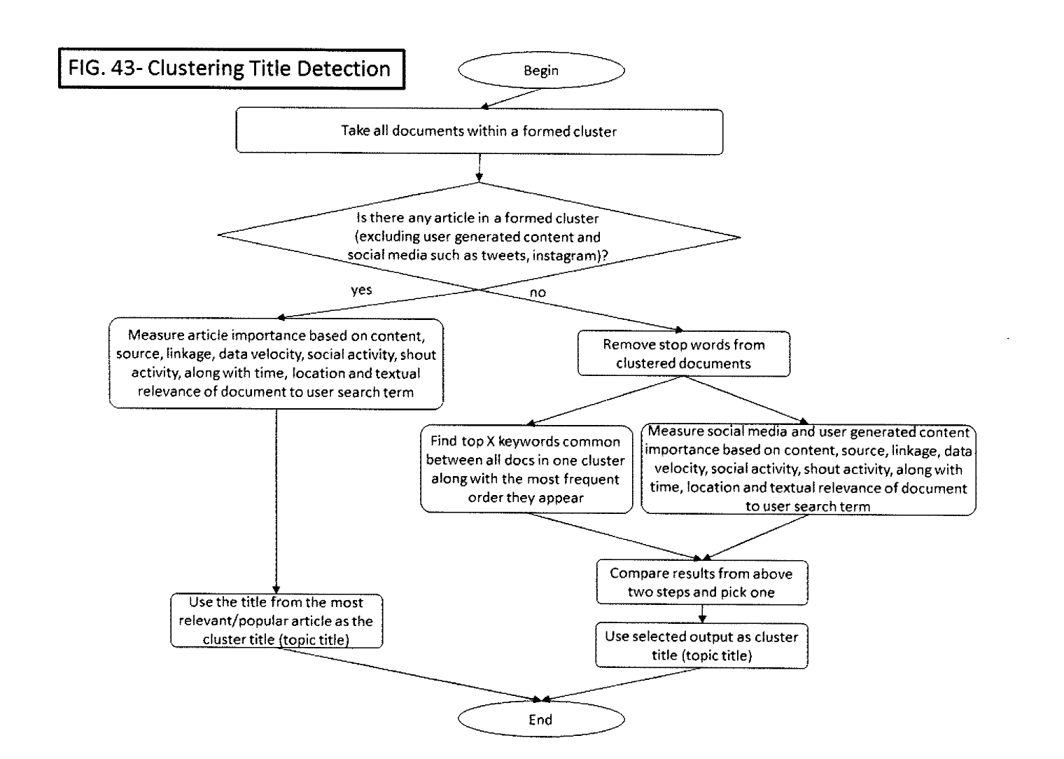

FIG. 43 illustrates an example simplified procedure for clustering title detection in accordance with one or more embodiments described herein (e.g., turning 5000 TWEETS into “Lady Gaga Concert”. In particular, all documents within a formed cluster are taken, and it is determined whether there is any article in a formed cluster (excluding user generated content and social media such as TWEETS, INSTAGRAM, etc.). If so, then article importance can be measured based on content, source, linkage, data velocity, social activity, shout activity, along with (for searches) time, location, and textual relevance of the document to a user search term, and the title from the most relevant/popular article may be used as the cluster title (topic title). If, however, there are no articles, then the system may remove stop words from clustered documents, and may a) find the top X keywords common between all documents in one cluster along with the most frequent order they appear, and b) measure social media and user generated content importance based on content, source, linkage, data velocity, social activity, shout activity, along with time, location and textual relevance of document to a user search term. By comparing the results from the above two steps, one title may be selected and used as the cluster title (topic title). Note that various filters may be put in place, such as using only titles, or only flagged keywords (e.g., names, locations, etc.). Also, the order of the words may be maintained in relevance, such as “Lady”+“Gaga”+“Concert” (“Lady Gaga Concert”) as opposed to “Gaga”+“Concert” “Lady” (“Gaga Concert Lady”).

FIG. 44 illustrates an example simplified procedure for a distance formula for clustering documents in accordance with one or more embodiments described herein. For any pair of documents, define distance difference by L, time difference by T, keyword similarity by K, social activity difference by S, number of embedded links difference by E, and size difference by Z. A distance DIS may then be defined between the two documents as a weighted function of a1*L+a2*T+a3*K+a4*S+a5*E+a6*Z (where a# is a configured and/or learned/adjusted weight), such that DIS can then be used to group documents into clusters. Note that if multiple “good” matches are found that are above the threshold, then the best match might be chosen and clustered.

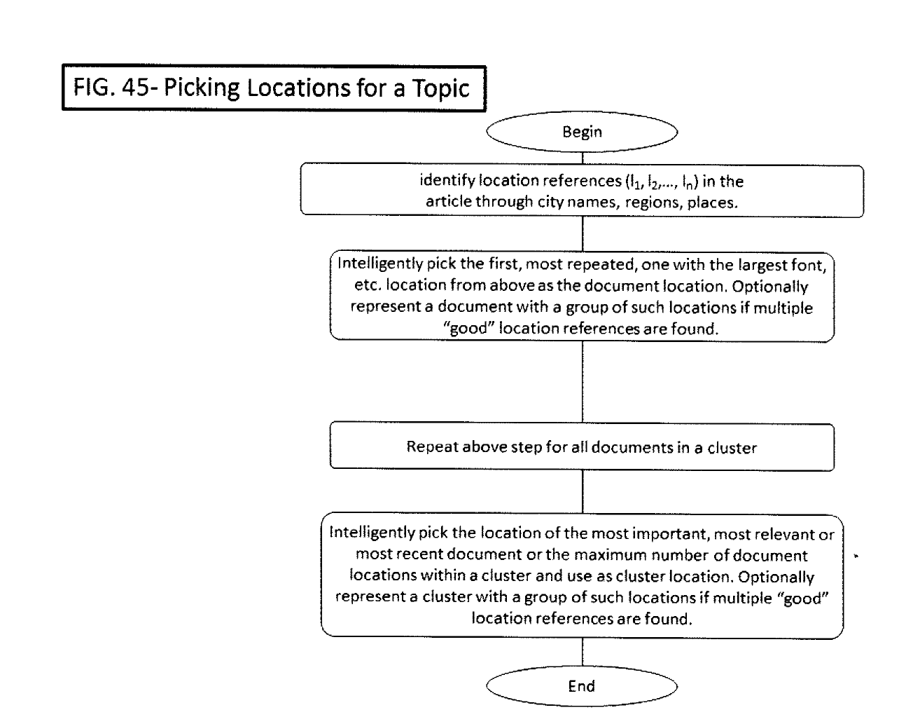

FIG. 45 illustrates an example simplified procedure for picking locations for a topic in accordance with one or more embodiments described herein. In particular, as mentioned above, location references (l1, l2, . . . , ln) may be identified in the articles/documents through city names, regions, places, and the system intelligently picks the location from the first, the most repeated, the one with the largest font, etc. location as the document location. Optionally a document may be represented with a group of such locations if multiple “good” location references are found. This step may be repeated for all documents in a cluster. The system may then intelligently pick the location of the most important, most relevant, or most recent document or the maximum number of document locations within a cluster and use it as the cluster's (topic's) location. Optionally, a cluster may also be represented with a group of such locations if multiple “good” location references are found.

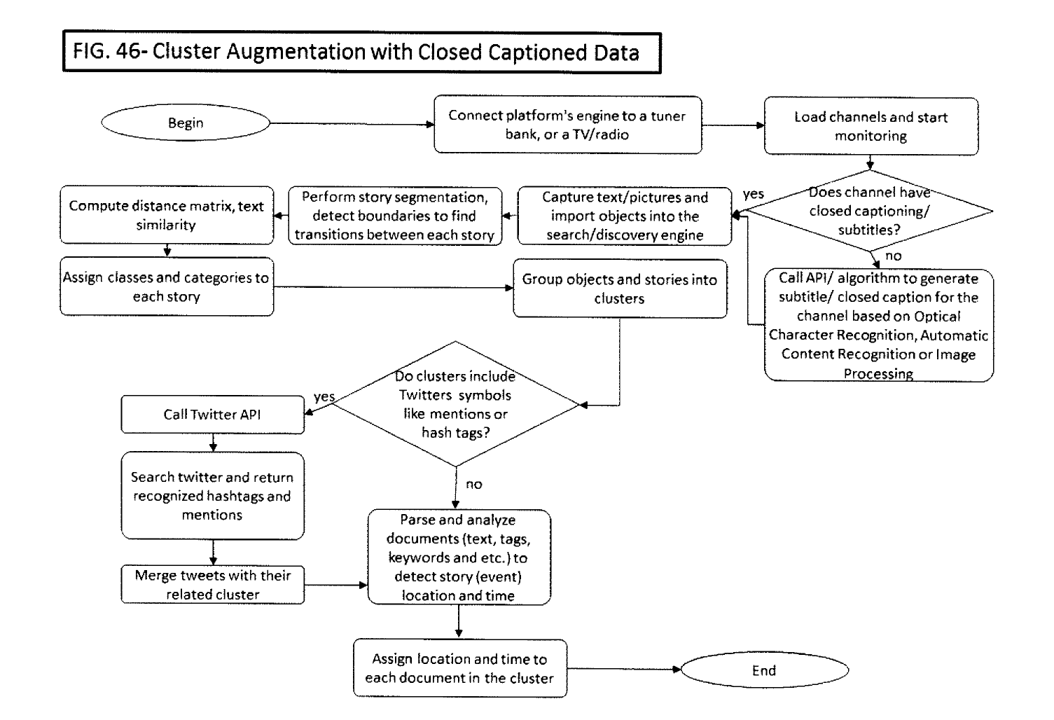

FIG. 46 illustrates an example simplified procedure for cluster augmentation with closed captioned data in accordance with one or more embodiments described herein. By connecting the platform's engine to a tuner bank, or a TV/radio, channels may be loaded and monitored to determine whether particular channels have closed captioning/subtitles. If not, then an API/algorithm may be called to generate subtitles/closed captions for the channel based on such things as Optical Character Recognition, Automatic Content Recognition, or Image Processing. The system captures text/pictures and imports objects into the search/discovery engine in order to perform story segmentation, detecting boundaries to find transitions between each story. A distance matrix and text similarity may be computed in order to assign classes and categories to each story, and then objects and stories may be grouped into clusters. If the clusters include TWITTER symbols like mentions or hashtags, then a TWITTER API can be called to search TWITTER (or other social media outlet) to return recognized hashtags and mentions, and such results (e.g., TWEETS) may be merged with their related cluster. The resultant documents (text, tags, keywords and etc.) may be parsed and analyzed to detect story (event) location and time, and the system assigns location and time to each document in the cluster. Note that closed caption data as a source to the system described herein is not only used to find locations, event detection, etc. (as discussed here), but they also act as another input source to the clustering algorithms herein, so events and stories identified will be fed into the system to be clustered with other information (TWEETS, INSTAGRAM photos, articles, etc.).

FIG. 47 illustrates an example simplified procedure for searching in accordance with one or more embodiments described herein. In particular, a user selects location(s) and keyword(s) and the request is sent to the platform's server(s). Optionally, the system reverse geocodes user's location filed in the search to a city, state, county, country and adds those identified locations as search keywords. The system then searches already indexed and augmented documents and finds those that are textually, spatially and/or temporally relevant (see “Distance Formula”) based on their data and metadata and user's search parameters. Note that if there are not enough relevant results found, then the system can increase the distance threshold (based on time, location, keywords and other document/cluster attributes) and perform the search again. Once a sufficient number of results are found, the system identifies a set of clusters that contain the above matched documents, while optionally adding matched documents that do not belong to any particular clusters to a single miscellaneous cluster. Cluster importance may be identified based on number of documents, importance of documents, linkage, data velocity, social activity, shout activity, along with time, location, and textual relevance of the cluster to the user search term(s), and the clusters may then be ranked based on the above importance. Documents within each cluster may then be ranked based on relevance to the user query, and the result is returned to the user.

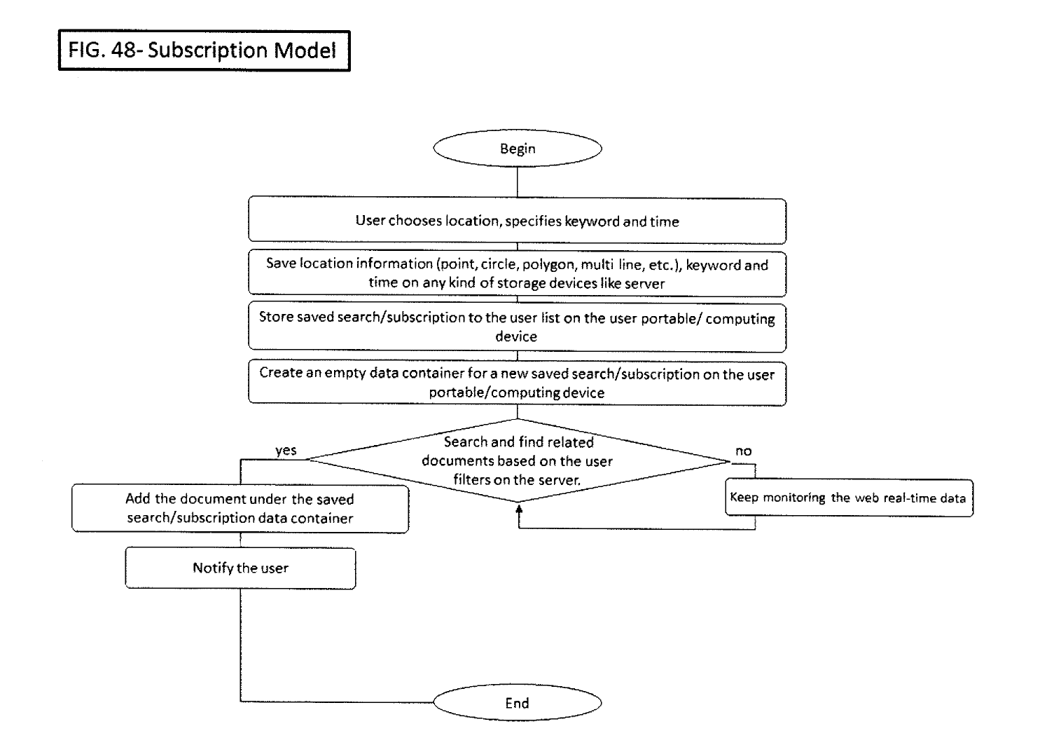

FIG. 48 illustrates an example simplified procedure for a subscription model in accordance with one or more embodiments described herein. For instance, a user chooses a location, specifies keyword(s) and time, and saves location information (point, circle, polygon, multiline, free-form shape, etc.), keyword and time on any kind of storage devices like a server. The saved search/subscription is also saved to the user's list on the user's portable/computing device. An empty data container (e.g., “inbox”) for a new saved search/subscription may then be created on the user portable/computing device. The system then searches and finds related documents based on the user filters on the server as described above. (Notably, textual relevance may be “fuzzy” as described above, such as where a user's search term is “emergency”, but when a “fire” or “robbery” happens, this would still match the search. Spatial searching can also be fuzzy, where a user selects a location (point), but something happens within a region that encloses or is near the point, thus still being considered a viable search match. The same is true for time.) If documents are found, they are added under the saved search/subscription data container, and the user is notified. If no documents are found, then the system keeps monitoring the web real-time data.

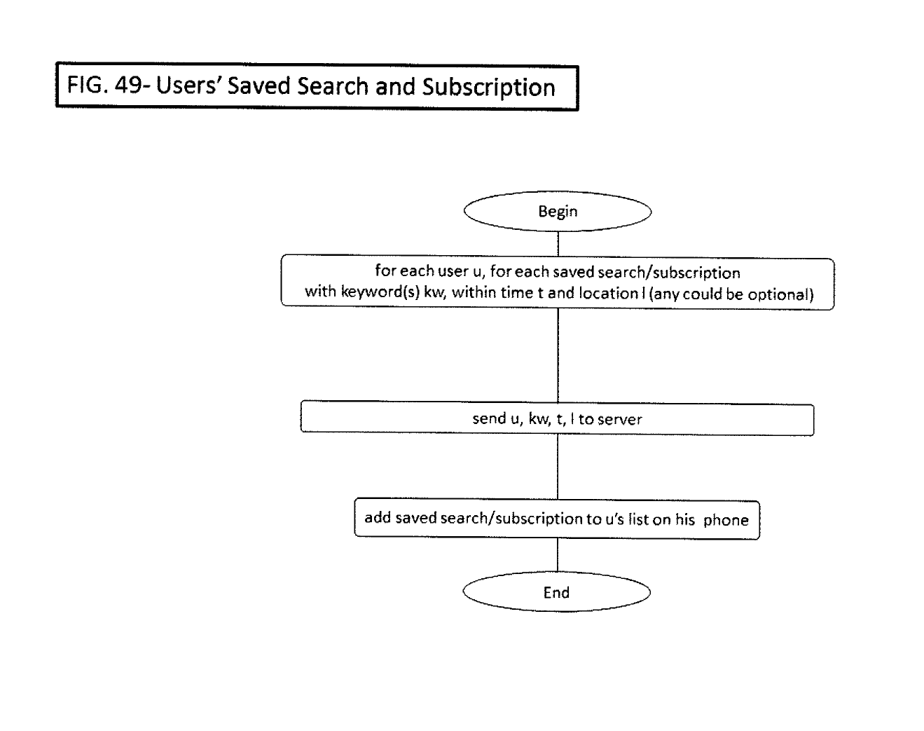

FIG. 49 illustrates an example simplified procedure for user's saved searches and subscriptions in accordance with one or more embodiments described herein. For each user u, for each saved search/subscription with keyword(s) kw, within time t and location l (any could be optional), the system sends u, kw, t, l to server, and adds the saved search/subscription to u's list on his/her computing device.

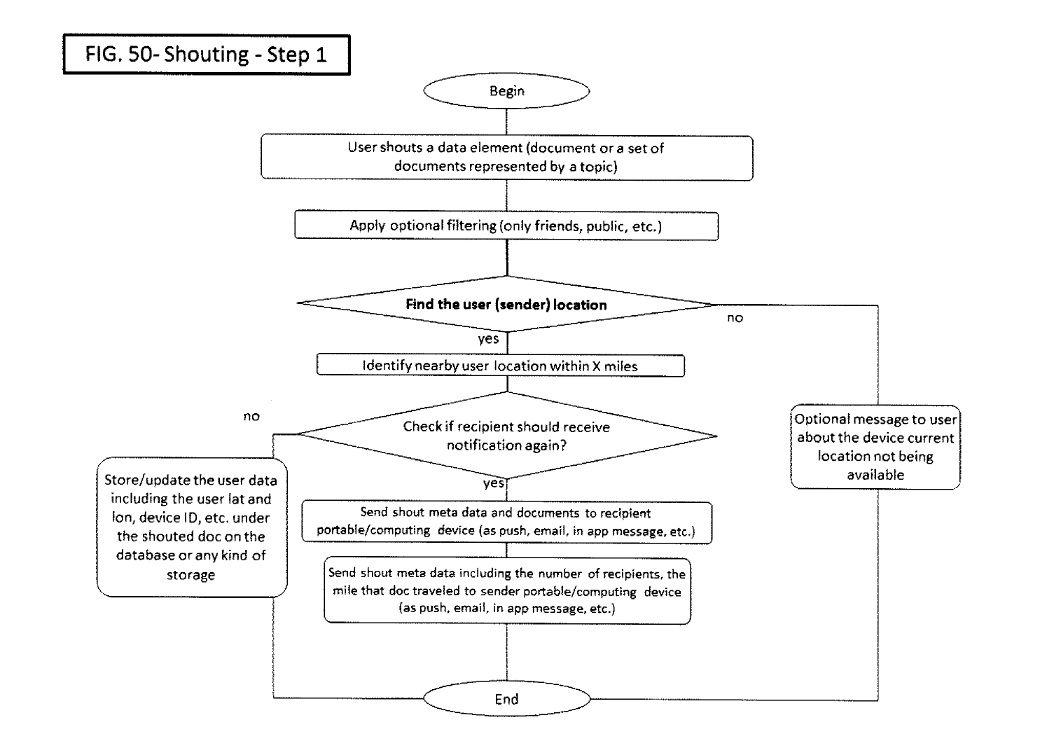

FIG. 50 illustrates an example simplified procedure for shouting (“step 1”) in accordance with one or more embodiments described herein. In particular, as described above, a user shouts a data element (document or a set of documents represented by a topic). Once applying optional filtering (only friends, public, etc.), the user's (sender's) location may be determined. (Note that the system may also update shout statistics on a server in a shout database (db) and documents db and optionally save the sender's latitude and longitude or other location information.) In one embodiment, if the user's location is unavailable, a message may be optionally sent to the user indicating as such. In another embodiment, the user may specify a location. By identifying the user's location, nearby user location may be identified, e.g., within X miles. If the recipient has not yet received the shout (check if the recipient should receive the notification again), then the system sends shout metadata and documents to the recipient's portable/computing device (as push, email, in app message, etc.). Also, the system sends shout metadata including the number of recipients, the miles that the shout traveled to, etc., to the sender portable/computing device (as push, email, in app message, etc.). Note that if a recipient should not receive the notification again, then the system may store/update the user data including the user's location (e.g., lat and lon), device ID, etc. under the shouted document/element on the database or any kind of storage.

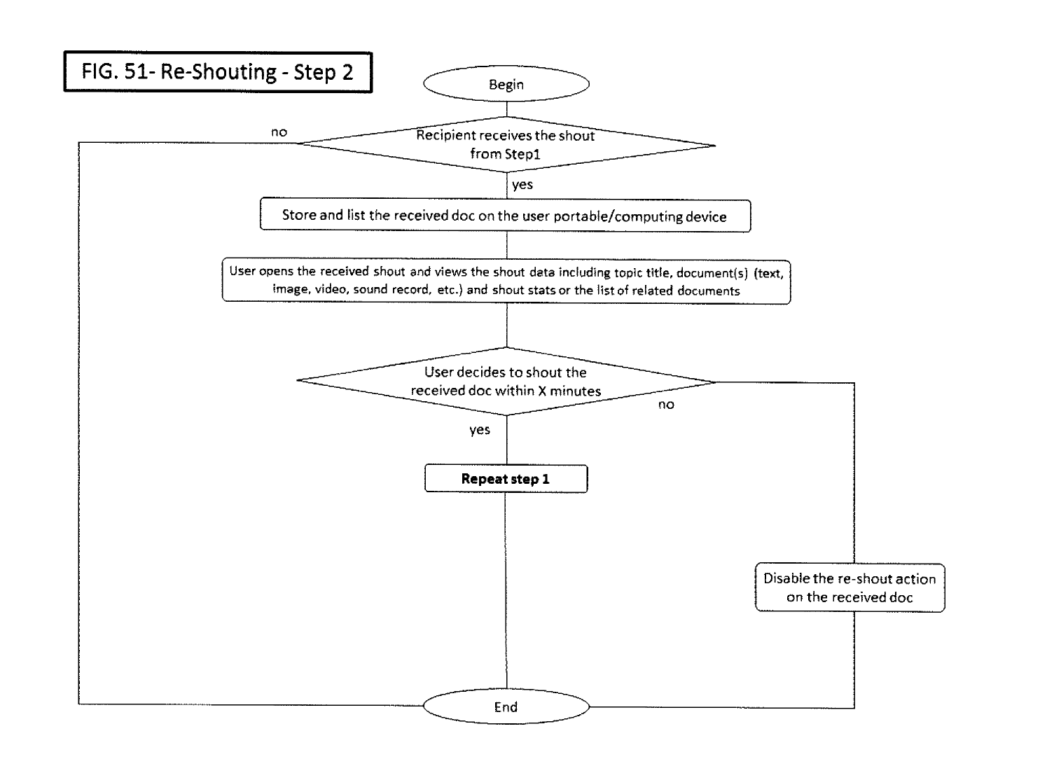

FIG. 51 illustrates an example simplified procedure for re-shouting (“step 2”) in accordance with one or more embodiments described herein. In particular, when the recipient receives the shout from Step 1 above (FIG. 50), then the system stores and lists the received shout/doc on the user's portable/computing device. When the user opens the received shout, he/she can view the shout data including topic title, document(s) (text, image, video, sound record, etc.), and shout stats or the list of related documents. If the user decides to shout the received doc (e.g., within X minutes), then Step 1 above is repeated. Otherwise, the re-shout action on the received doc may be disabled.

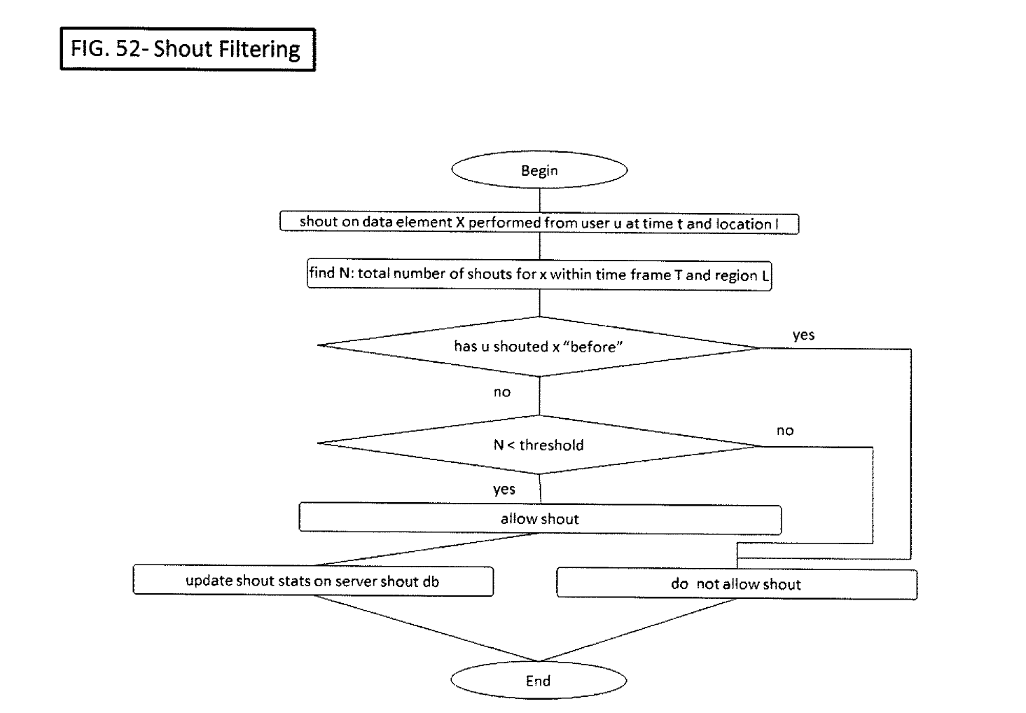

FIG. 52 illustrates an example simplified procedure for shout filtering in accordance with one or more embodiments described herein. If a shout on data element X is performed from user u at time t and location 1, the system finds N as a total number of shouts for X within time frame T and region L. If the user u has shouted X “before”, then the shout may be disallowed. If not, however, and if N is less than a threshold maximum amount of shouts about X, then the shout is allowed (e.g., updating shout stats).

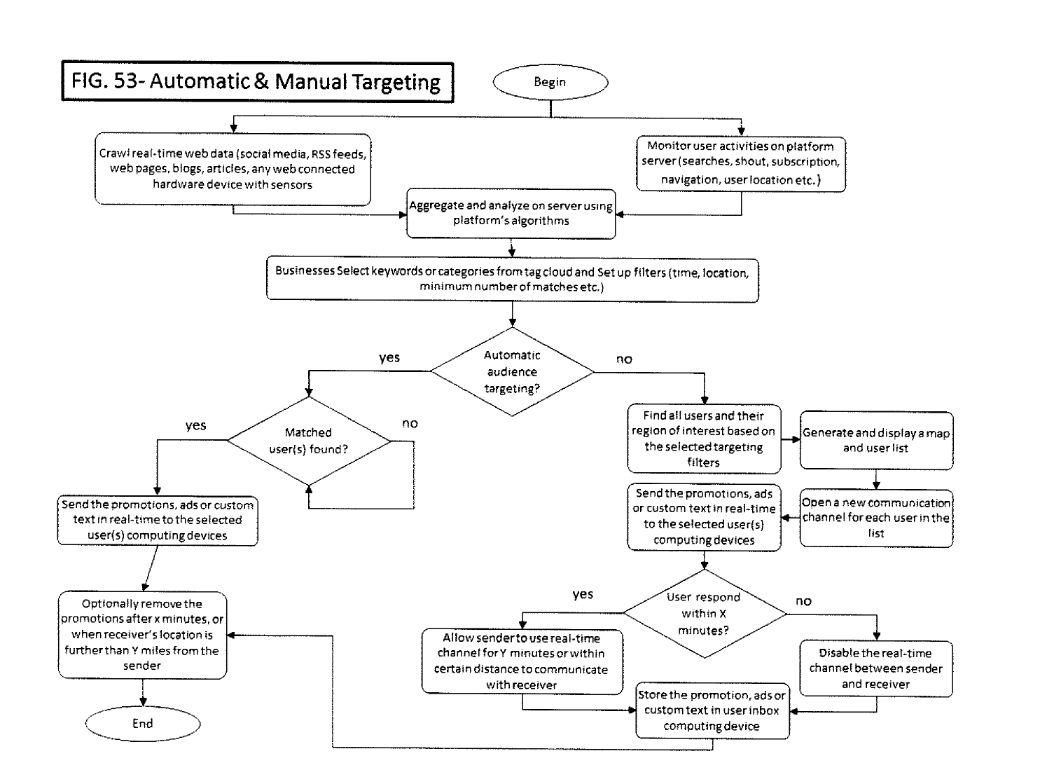

FIG. 53 illustrates an example simplified procedure for automatic and manual targeting in accordance with one or more embodiments described herein. The system crawls real-time web data (social media, RSS feeds, web pages, blogs, articles, any web connected hardware device with sensors, etc.) and monitors user activities on platform servers (searches, shout, subscription, navigation, user location etc.). These results may be aggregated and analyzed on the server(s) using the platform's algorithms. Businesses select keywords or categories from tag cloud and set up filters (time, location, minimum number of matches, etc.) For automatic audience targeting, the system waits for matched user(s), and send promotions, ads or custom text in real-time to the selected user's (users') computing device(s), optionally removing the promotions after x minutes, or when receiver's location is further than Y miles from the sender. Alternatively, for manual targeting, the system finds all users and their region of interest based on the selected targeting filters, and may generate and display a map and user list to the business, opening a new communication channel for each user in the list. The business may then send the promotions, ads or custom text in real-time to the selected user(s). If the user responds (e.g., within X minutes), then the sender is allowed to use a real-time channel for Y minutes or within a certain distance to communicate with receiver. If the user does not respond, then the system disables the real-time channel between sender and receiver. Note that the promotion, ads, or custom text may be stored in the user's inbox on their computing device.

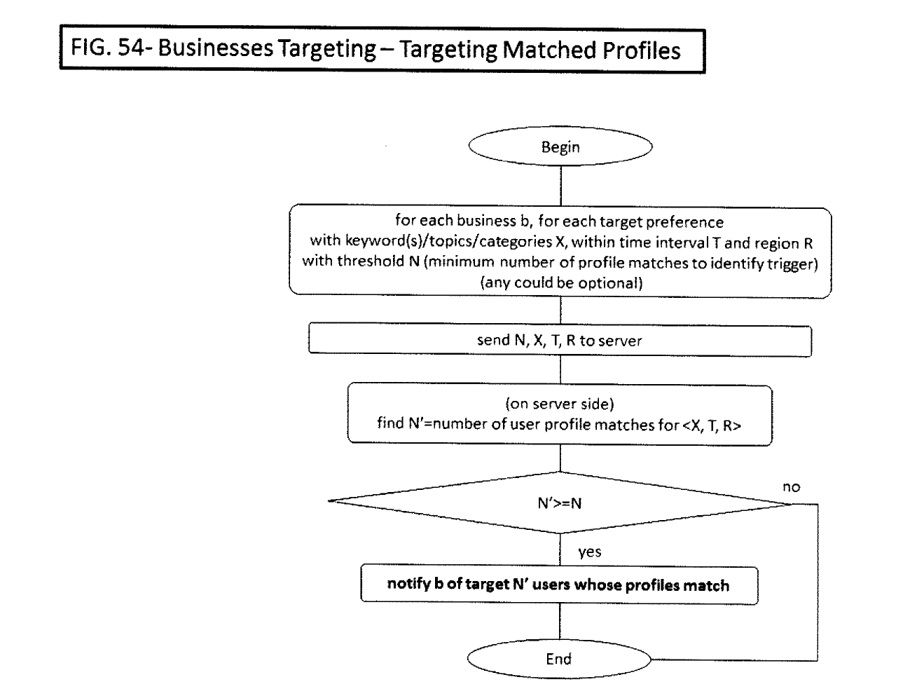

FIG. 54 illustrates an example simplified procedure for business targeting (targeting matched profiles) in accordance with one or more embodiments described herein. For each business b, for each target preference with keyword(s)/topics/categories X, within time interval T and region R with threshold N (minimum number of profile matches to identify trigger) (any could be optional), the system sends N, X, T, R to the server. The server may then find N′=number of user profile matches for <X, T, R>. If N′>=N, then the server may notify b of the target N′ users whose profiles match.

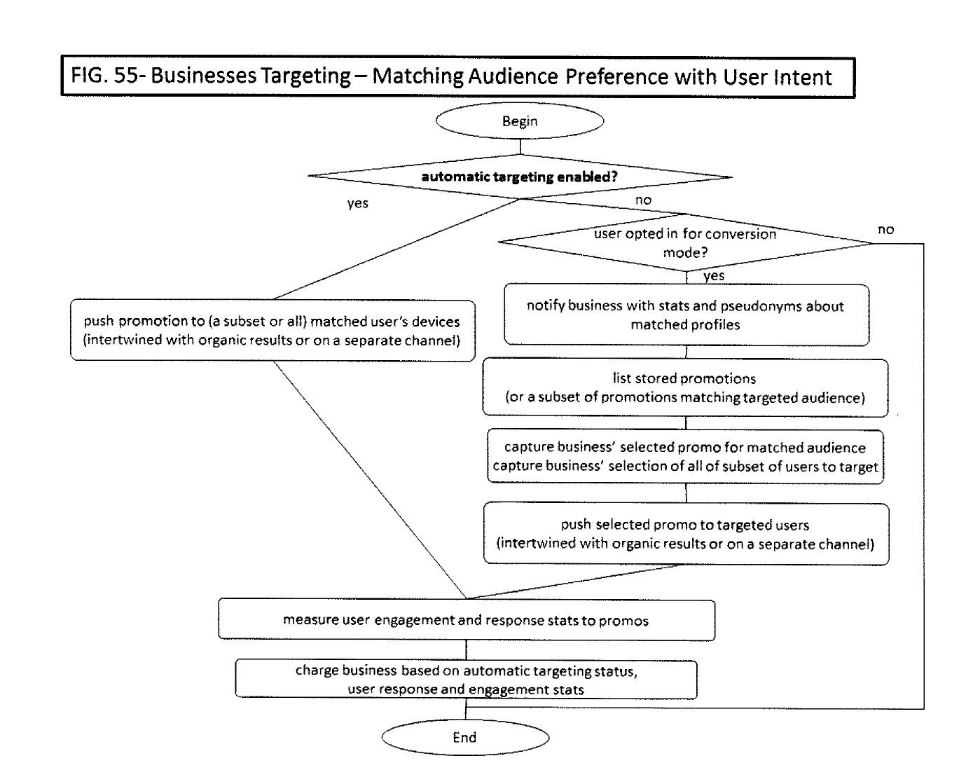

FIG. 55 illustrates an example simplified procedure for business targeting (matching audience preference with user intent) in accordance with one or more embodiments described herein. If automatic targeting is enabled, then a promotion may be pushed to (a subset or all) matched user's devices (intertwined with organic results or on a separate channel). On the other hand, if automatic targeting is not enabled, then the system determines whether a particular user opted in for conversion (or conversation) mode. If so, then the system notifies a business with stats and pseudonyms about matched profiles, and lists stored promotions (or a subset of promotions matching the targeted audience), captures the business' selected promo for matched audience, and captures the business' selection of all of subset of users to target. The selected promo may then be pushed to targeted users (intertwined with organic results or on a separate channel). In one embodiment (automatic targeting or otherwise), the system may measure user engagement and response statistics to the promos. In addition, the system may automatically charge businesses based on automatic targeting status, user response, and engagement statistics.

It should be noted that while certain steps within the procedures may be optional as described above, the steps shown in FIGS. 41-55 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while the procedures are described separately, certain steps from each procedure may be incorporated into each other procedure, and the procedures are not meant to be mutually exclusive.

Advantageously, the techniques herein provide for time and location based online searching. In particular, as described above, the techniques herein allow for the searching to cover past, present, and future events, for either a user's current location, future location, or a specified location. Additionally, the techniques herein provide user-friendly search results in the form of stories and topics, rather than merely millions of data points that are difficult to navigate (e.g., clustering data points into stories/topics, such as not returning 3000 TWEETS, but instead an event titled “Plane Crash in SFO”). Furthermore, in addition to mere news, the techniques herein provide users with “hyper-local” user-generated content (e.g., TWEETS, community posts, etc.).

Note also that in certain embodiments, data authenticity may be verified, such as by confirming when and where something happened (e.g., whether a post about a bridge collapse came from a location near the collapse, based on data coming straight from the phones with automatic location/time tags). This may be particularly useful for news outlets, criminal investigations, etc. For example, while shouting a topic/event, cross-reference to a user's GPS-based or network-based location may be used.

Furthermore, as described above, the techniques herein provide business value whether or not there are users of the application, since in addition to aggregating an “intent model” of what users are interested in what topics in what locations and at what times, other non-user-based information is also made available, such as information on data located within from various elements within the Internet.

The embodiments described herein, therefore, provide for time and location based online searching with various novel features. While there have been shown and described illustrative embodiments, it is to be understood that various other adaptations and modifications may be made within the spirit and scope of the embodiments herein. For example, various additions for cross-lingual (e.g., translation services and clustering) may also be considered within the scope of the techniques herein, matching and categorizing information from multiple language sources and locations.

In addition, although the description above focuses on effectively searching user-generated real-time and location data, the underlying technology can be used for managing different types of time and location sensitive data. In particular the same techniques can be used to ingest, organize, and search data generated by smart devices, “internet of things” or what is called the “outernet”. For example, instead of learning about the “plane crash” in San Francisco from “user generated data”, one would learn about the “mass power outage” in San Francisco from “smart devices” reporting malfunctions. Or one can learn about “a bridge about to collapse” in San Francisco from 200 nearby sensors and 20 monitoring tools all generated some sort of alert which in the techniques herein are turned into an “event” or “topic” and presented to a (power) user on a device. Finally, assume a user walking to a museum or a theme park can be presented with a set of topics (such as “wait time”, “next tour”, “discounts”, etc.) that are automatically generated by the platform herein from the data each building, ride in a theme park, tour in a museum, etc. shares with the platform engine automatically. Still further, if a user is driving toward a carwash, the platform can automatically warn him/her about “abnormal wait time” in the carwash due to automatically inferring from check-in check-out time of the cars and an “event” (e.g., “too much wait”) could be presented to the user. As even more examples, the techniques herein can automatically identify a “rough highway section” due to many cars reporting “low tire pressure” within a certain time of driving through that section of the highway. Finally, each “object” may be equipped with an RFID or a similar technology (NFC, etc.) and the platform herein receives all of this data (which is time and location sensitive) and applies the techniques herein to the data received from these objects. Also, one can imagine how data generated by users, data crawled from exiting articles, and data coming from the “web of things” can be aggregated or clustered together to provide more context to users (for instance, when they travel to a new location or arrive at a new space).

Also, while data may generally be ingested from external sources, the platform herein may act as a time and location based publishing platform where Tilos (channels) can be created and their content can be curated by businesses and individuals for commercial or private use cases. For instance a dad can create a private Tilo for his family where everything they need to know when they arrive home is already placed in that Tilo/channel. A couple would do the same thing for their wedding and a business might create a Tilo/channel for their annual summit.

Still further, some “gamification” (game-play) can be added to the system where users have to unlock a trajectory a certain number of times or shout things a certain number of times, or obtain shout statistics that cover X number of people in a region and so on to receive “rewards”.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. An apparatus comprising:
a memory configured to store instructions;
a processor configured to execute the instructions stored on the processor, the instructions when executed:
determine a location of the apparatus and a time; and
perform real-time search and discovery of at least one of a topic, a story, an event, or an incident associated with at least the location and the time.

2. The apparatus of claim 1, wherein the location is a current location or a specified location.

3. The apparatus of claim 1, wherein the location is determined via a global positioning system.

4. The apparatus of claim 1, wherein the time is selected from a group consisting of a current time or a specified time.

5. A method comprising:
determining, by a processor, a location of an apparatus and a time; and
performing, by the processor, a real-time search and discovery of at least one of a topic, a story, an event, or an incident associated with at least the location and the time.

6. The method of claim 5, wherein the location is a current location or a specified location.

7. The method of claim 5, further comprising: determining the location via a global positioning system.

8. The method of claim 5, wherein the time is selected from a group consisting of a current time or a specified time.
